(19) United States
(12) Patent Application Publication
(10) Pub. No.: US 2025/0244952 A1
(43) Pub. Date: Jul. 31, 2025

(54) SECURE ADDER HAVING CARRY-SAFE ADDER TO VERIFY RESULT OF SECURE ADDITION OPERATION PERFORMED BY SECURE CARRY-LOOKAHEAD ADDER

(71) Applicant: Nuvoton Technology Corporation, Hsinchu Science Park (TW)

(72) Inventors: Kun-Yi WU, Tainan City (TW); Yu-Shan LI, Tainan City (TW)

(21) Appl. No.: 19/011,927

(22) Filed: Jan. 7, 2025

(30) Foreign Application Priority Data
Jan. 29, 2024 (TW) 113103316

(51) Int. Cl. G06F 7/508; G06F 7/502

(52) U.S. Cl. CPC G06F 7/508; G06F 7/502

(57) ABSTRACT

A secure adder includes a mask generator, a secure carry-lookahead adder, and a verification circuit. The mask generator generates a first mask value, a second mask value, a third mask value, first masked data, and second masked data. The secure carry-lookahead adder performs an operation on the first masked data and the second masked data to generate a sum output according to the first mask value, the second mask value, and the third mask value. The verification circuit includes a secure carry-save adder and a comparator. The secure carry-save adder generates sum data and carry data according to the first mask value, the second mask value, the third mask value, the first masked data, the second masked data, and the sum output. The comparator generates a verification output according to the relationship between the sum data and the carry data.

### CROSS REFERENCE TO RELATED APPLICATIONS

This application claims priority of Taiwan Patent Application No. 113103316, filed on Jan. 29, 2024, the entirety of which is incorporated by reference herein.

### BACKGROUND OF THE INVENTION

### Field of the Invention

The disclosure is generally related to a secure adder, and more particularly it is related to a secure adder that uses a carry-safe adder to verify the result of a secure addition operation performed by a secure carry-lookahead adder.

### Description of the Related Art

Addition is an important function of many operations, so adders are widely used in various applications, such as signal processing, data protection, and so on. In recent years, encryption and decryption applications have attached great importance to protect confidential information, to prevent data from being stolen and analyzed. In general, a common and effective protection mechanism is exclusion (or mask) technology, which utilizes random numbers and important data (or variables) in an encryption and decryption algorithm to perform an exclusive-OR (XOR) operation to complete the mask protection mechanism. Therefore, encryption and decryption applications need a secure adder that can perform secure addition operations.

A secure addition operation requires a secure adder that can complete the addition operation without removing the mask of input data and revealing the original value of the input data during the calculation process, to provide the outputs protected by mask values. Secure adders that can perform secure addition operations are widely used in various integrated circuits (ICs) and in electronic products used in encryption and decryption applications.

In order to ensure the correctness of the secure addition operation and prevent malicious attacks, the secure adder needs an effective countermeasure to detect errors. Unfortunately, there is currently no literature that proposes effective countermeasures for secure adder verification.

### BRIEF SUMMARY OF THE INVENTION

In an embodiment, a secure adder is provided, which comprises a mask generator, a secure carry-lookahead adder, and a verification circuit. The mask generator is configured to generate a first mask value, a second mask value and a third mask value, to generate first masked data according to the first mask value, and to generate second masked data according to the second mask value. The secure carry-lookahead adder performs an operation on the first masked data and the second masked data according to the first mask value, the second mask value, and the third mask value to generate a sum output. The verification circuit comprises a secure carry-save adder and a comparator. The secure carry-save adder generates sum data and carry data according to the first mask value, the second mask value, the third mask value, the first masked data, the second masked data, and the sum output. The comparator generates a verification result according to the relationship between the sum data and the carry data.

According to some embodiments of the present invention, the secure carry-lookahead adder further comprises a first exclusive-OR (XOR) gate, a second mask unit, a half adder, a third mask unit, a first logic circuit, a carry-lookahead generator, and a second XOR gate. The first XOR gate is configured to receive the first mask value and the second mask value, to provide a variable. The second mask unit is configured to perform a third mask operation on the first masked data according to the variable, to obtain third masked data. The half adder is configured to receive the third masked data and the second masked data, to generate a propagation value and an intermediate generation value. The third mask unit is configured to perform a fourth mask operation on the propagation value according to the third mask value, to obtain fourth masked data. The first logic circuit is configured to provide a generation value according to the propagation value, the intermediate generation value, and the second mask value. The carry-lookahead generator is configured to provide a carry output and a carry value according to a carry input, the generation value, and the propagation value. The second XOR gate is configured to receive the fourth masked data and the carry value, to provide a sum output.

According to some embodiments of the present invention, the second mask unit comprises a third XOR gate. The third XOR gate is configured to receive the variable and the first masked data, to provide the third masked data.

According to some embodiments of the present invention, the third mask unit comprises a fourth XOR gate. The fourth XOR gate is configured to receive the third mask value and the propagation value, to provide the fourth masked data.

According to some embodiments of the present invention, the half adder comprises a first AND gate and a fifth XOR gate. The first AND gate is configured to receive the third masked data and the second masked data, to provide the intermediate generation value. The fifth XOR gate is configured to receive the third masked data and the second masked data, to provide the propagation value.

According to some embodiments of the present invention, the logic circuit comprises a sixth XOR gate, a second AND gate, and a seventh XOR gate. The sixth XOR gate is configured to receive the intermediate generation value and the second mask value, to provide first intermediate data. The second AND gate is configured to receive the propagation value and the second mask value, to provide second intermediate data. The seventh XOR gate is configured to receive the first intermediate data and the second intermediate data, to provide the generation value.

According to some embodiments of the present invention, the secure adder further comprises a bus interface. The bus interface is configured to provide the first data and the second data from a bus to the mask generator.

According to some embodiments of the present invention, the secure adder further comprises a selection circuit and a storage circuit. The selection circuit is configured to selectively provide the first mask value, the second mask value, the third mask value, the first masked data and the second masked data from the mask generator or the first mask value, the second mask value, the third mask value, the first masked data, and the second masked data generated by an external circuit from the bus to the carry-lookahead generator. The storage circuit is coupled between the selection circuit and the carry-lookahead adder, and configured to store the first mask value, the second mask value, the third mask value, the first masked data, and the second masked data from the selection circuit.

According to some embodiments of the present invention, the mask generator comprises a random number generator and a first mask unit. The random number generator is configured to randomly generate the first mask value, the second mask value, and the third mask value. The first mask unit is configured to perform a first mask operation on first data according to the first mask value to obtain the first masked data, and performing a second mask operation on second data according to the second mask value to obtain the second masked data.

According to some embodiments of the present invention, the secure carry-save adder comprises a fourth mask unit, a fifth mask unit, a sixth mask unit, and an eighth XOR gate. The fourth mask unit is configured to perform a fifth mask operation according to the first mask value, a first conversion variable, the sum output, and a second conversion variable to obtain a first variable. The fifth mask unit is configured to perform a sixth mask operation on the second masked data according to the first mask value and the second mask value to obtain fifth masked data. The sixth mask unit is configured to perform a seventh mask operation on the first masked data according to the first mask value and the third mask value to obtain sixth masked data. The eighth XOR gate is configured to receive the fifth masked data, the sixth masked data, and the first variable to provide sum data of the first masked data, the second masked data, and the sum output.

According to some embodiments of the present invention, the secure carry-save adder further comprises a second logic circuit. The second logic circuit is configured to receive the fifth masked data, the sixth masked data, and the second conversion variable to provide the first masked data, the second masked data, and the carry data of the sum output.

According to some embodiments of the present invention, the second logic circuit comprises a third AND gate, a fourth AND gate, a fifth AND gate, and an OR gate. The third AND gate is configured to receive the fifth masked data and the sixth masked data to provide first intermediate data. The fourth AND gate is configured to receive the fifth masked data and the second conversion variable to provide second intermediate data. The fifth AND gate is configured to receive the sixth masked data and the second conversion variable to provide third intermediate data. The OR gate is configured to receive the first intermediate data, the second intermediate data, and the third intermediate data to provide the carry data.

According to some embodiments of the present invention, the verification circuit further comprises a first conversion circuit. The first conversion circuit comprises a first shift circuit and a first inverter. The first shift circuit left-shifts the first mask value to generate the first conversion variable. The first inverter inverts the sum output to generate the second conversion variable.

According to some embodiments of the present invention, the fifth mask unit comprises a ninth XOR gate and a tenth XOR gate. The ninth XOR gate is configured to receive the first mask value and the second mask value to provide a third variable. The tenth XOR gate is configured to receive the third variable and the second masked data to provide the fifth masked data.

According to some embodiments of the present invention, the sixth mask unit comprises an eleventh XOR gate and a twelfth XOR gate. The eleventh XOR gate is configured to receive the first mask value and the third mask value to provide a fourth variable. The twelfth XOR gate is configured to receive the fourth variable and the first masked data to provide the sixth masked data.

According to some embodiments of the present invention, the fourth mask unit comprises a thirteenth XOR gate and a fourteenth XOR gate. The thirteenth XOR gate is configured to receive the first mask value and the first conversion variable to provide a second variable. The fourteenth XOR gate is configured to receive the second variable and the sum output to provide the first variable.

According to some embodiments of the present invention, the verification circuit further comprises a second conversion circuit. The second conversion circuit comprises a second shift circuit. The second shift circuit left-shifts the carry data by one bit to generate a left-shifted carry data. The comparator is configured to compare the sum data and the left-shifted carry data. When the sum data is equal to the left-shifted carry data, the verification result indicates that the operation of the secure carry-lookahead adder is correct.

According to some embodiments of the present invention, the fourth mask unit comprises a thirteenth XOR gate and a fourteenth XOR gate. The thirteenth XOR gate is configured to receive the first mask value and the first conversion variable to provide a second variable. The fourteenth XOR gate is configured to receive the second variable and the second conversion variable to provide the first variable.

According to some embodiments of the present invention, the verification circuit further comprises a second conversion circuit. The second conversion circuit comprises a second shift circuit and a second inverter. The second shift circuit left-shifts the carry data by one bit to generate a left-shifted carry data. The second inverter inverts the sum data to generate inverted sum data. The comparator is configured to compare the inverted sum data and the left-shifted carry data. When the sum data is equal to the left-shifted carry data, the verification result indicates that the operation of the secure carry-lookahead adder is correct.

In another embodiment, an execution method for executing secure addition is provided, which comprises the following steps. A first mask value, a second mask value, and a third mask value are generated. First masked data is generated according to the first mask value. Second masked data is generated according to the second mask value. An operation is performed on the first masked data and the second masked data according to the first mask value, the second mask value, and the third mask value to generate a sum output. Sum data and carry data are generated according to the first mask value, the second mask value, the third mask value, the first masked data, the second masked data, and the sum output. A verification result is generated according to the relationship between the sum data and the carry data.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a block diagram of a secure adder 100 in accordance with some embodiments of the present invention;

FIG. 2 is a flow chart of a method of performing carry-lookahead addition for the secure carry-lookahead adder in accordance with some embodiments of the present invention;

FIG. 3A shows an exemplary circuit of the secure carry-lookahead adder of the first type in accordance with some embodiments of the present invention;

FIG. 3B shows an exemplary circuit of the secure carry-lookahead adder of the second type in accordance with some embodiments of the present invention;

FIG. 4 is a schematic diagram of a 4-bit carry-lookahead generator 400 illustrating the carry-lookahead generator in accordance with some embodiments of the present invention;

FIG. 5 is a flowchart showing a method of performing a secure carry-save addition according to some embodiments of the present invention;

FIG. 6 shows a truth table of the variable Exy in accordance with some embodiments of the present invention;

FIG. 7 is a truth table showing the original output value carry of equation (50) in accordance with some embodiments of the present invention;

FIG. 8 is a truth table showing the masked data carry″ of equation (60) in accordance with some embodiments of the present invention;

FIG. 9A is an exemplary circuit diagram showing a secure carry-save adder in accordance with some embodiments of the present invention;

FIG. 9B is an exemplary circuit diagram showing a secure carry-save adder in accordance with some embodiments of the present invention;

FIG. 9C is an exemplary circuit diagram showing a secure carry-save adder in accordance with some embodiments of the present invention;

FIG. 10 is a circuit diagram showing a verification circuit in accordance with an embodiment of the present invention;

FIG. 11 is a circuit diagram showing a verification circuit in accordance with another embodiment of the present invention; and

FIG. 12 is a flowchart showing an execution method for executing secure addition in accordance with an embodiment of the present invention.

### DETAILED DESCRIPTION OF THE INVENTION

The following description is made for the purpose of illustrating the general principles of the disclosure and should not be taken in a limiting sense. The scope of the disclosure is determined by reference to the appended claims.

In the following detailed description, for purposes of explanation, numerous specific details and embodiments are set forth in order to provide a thorough understanding of the present disclosure. The use of like and/or corresponding numerals in the drawings of different embodiments does not suggest any correlation between different embodiments.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In addition, in this specification, relative spatial expressions are used. For example, “lower”, “bottom”, “higher” or “top” are used to describe the position of one element relative to another. It should be appreciated that if a device is flipped upside down, an element that is “lower” will become an element that is “higher”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section in the specification could be termed a second element, component, region, layer, portion or section in the claims without departing from the teachings of the present disclosure.

It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

The terms “approximately”, “about” and “substantially” typically mean a value is within a range of +/−20% of the stated value, more typically a range of +/−10%, +/−5%, +/−3%, +/−2%, +/−1% or +/−0.5% of the stated value. The stated value of the present disclosure is an approximate value. Even there is no specific description, the stated value still includes the meaning of “approximately”, “about” or “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In the drawings, similar elements and/or features may have the same reference number. Various components of the same type can be distinguished by adding letters or numbers after the component symbol to distinguish similar components and/or similar features.

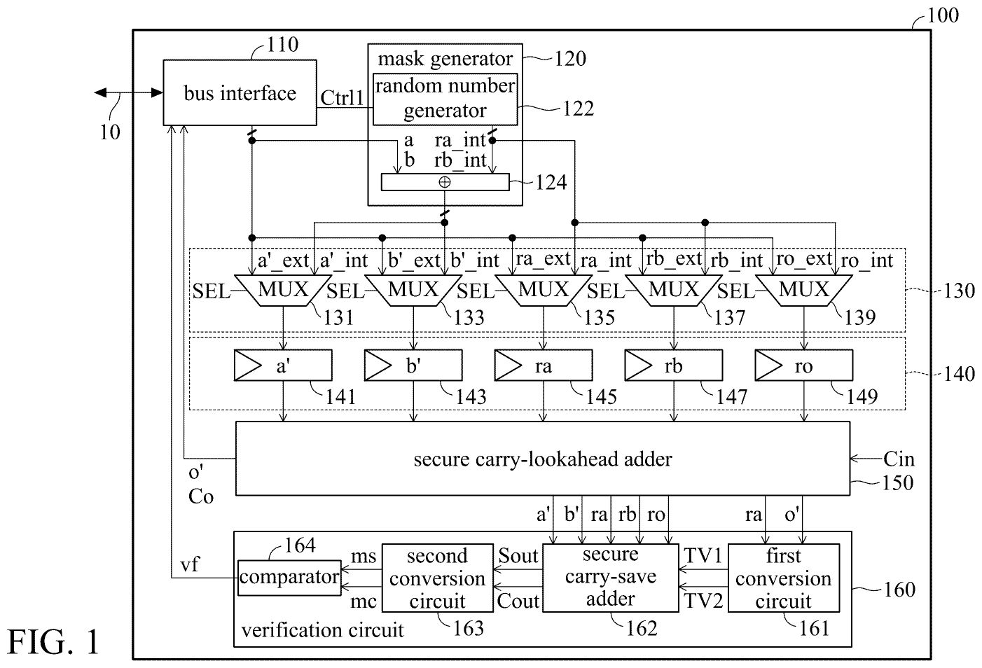

FIG. 1 shows a block diagram of a secure adder 100 in accordance with some embodiments of the present invention. In some embodiment, the secure adder 100 may be implemented in an integrated circuit (IC) (not shown). In addition, the secure adder 100 can complete the addition operation without leaking operands, and provide mask protection for the output result. In some embodiments, the secure adder 100 is configured to perform data transfer via the bus 10 and other circuits (not shown) within the IC. For example, a processor (not shown) may provide a plurality of input data (or operands) to the secure adder 100 via the bus 10 to perform the addition operations. In some embodiments, the input data may be unmasked raw data. In some embodiments, the input data may be masked data. Furthermore, after completing the addition operations, the secure adder 100 is configured to provide the masked operation result to the processor via the bus 10.

As shown in FIG. 1, the secure adder 100 includes a bus interface 110, a mask generator 120, a selection circuit 130, a storage circuit 140, a secure carry-lookahead adder (SCLA) 150, and a verification circuit 160. The bus interface 110 is coupled to the bus 10 and configured to provide various input data (e.g., operands, mask values, control signals, etc.) from the bus 10 to the mask generator 120, the selection circuit 130 and the secure carry-lookahead adder 150. After the addition operation is completed, the bus interface 110 is configured to provide output data (e.g., operation results) from the secure carry-lookahead adder 150 to the bus 10. Moreover, the output data of the secure carry-lookahead adder 150 is verified by the verification circuit 160, and the verification result is provided to the bus 10.

The mask generator 120 includes a random number generator (RNG) 122 and a first mask unit 124. According to the control signal Ctrl1 from the bus interface 110, the random number generator 122 is configured to generate a plurality of random numbers as the first internal mask value ra_int, the second internal mask value rb_int, and the third internal mask value ro_int. In some embodiments, the first internal mask value ra_int is different from the second internal mask value rb_int. In some embodiments, the first internal mask value ra_int is equal to the second internal mask value rb_int.

The random number generator 122 is configured to provide the first internal mask value ra_int and the second internal mask value rb_int to the first mask unit 124 and to provide the first internal mask value ra_int, the second internal mask value rb_int, and the third internal mask value ro_int to the selection circuit 130. In some embodiments, the control signal Ctrl1 is provided by an external circuit (i.e., other circuits in the IC) via the bus 10. In some embodiments, the bus interface 110 is configured to generate the control signal Ctrl1 to the mask generator 120 according to the input data from the bus 10.

In addition, the first mask unit 124 is configured to perform mask operations on the first data a and the second data b according to the first internal mask value ra_int and the second internal mask value rb_int, respectively, so as to obtain the first internal masked data a′_int and the second internal masked data b′_int. In general, the mask operation means to perform an exclusive-OR (XOR) operation between multi-bit data and multi-bit mask value, so as to mask out a portion of the bits in the data and provide the masked data, thereby preventing from being stolen. Furthermore, the first mask unit 124 is configured to further provide the first internal masked data a′_int and the second internal masked data b′_int to the selection circuit 130. In addition, the first data a and the second data b are provided by the external circuit via the bus 10.

The selection circuit 130 includes a plurality of multiplexers (MUX). As shown in FIG. 1, they are the first multiplexer 131, the second multiplexer 133, the third multiplexer 135, the fourth multiplexer 137, and the fifth multiplexer 139. In such embodiments, the first multiplexer 131, the second multiplexer 133, the third multiplexer 135, the fourth multiplexer 137, and the fifth multiplexer 139 are controlled by the same selection signal SEL. In some embodiments, the selection signal SEL is provided by an external circuit via the bus 10. In some embodiments, the bus interface 110 is configured to generate the selection signal SEL to the selection circuit 130 according to the input data from the bus 10.

When the selection signal SEL has a first logic level, the selection signal SEL is configured to control the first multiplexer 131, the second multiplexer 133, the third multiplexer 135, the fourth multiplexer 137, and the fifth multiplexer 139 to provide the first external masked data a′_ext and the second external masked data b′_ext and the first external mask value ra_ext, the second external mask value rb_ext, and the third external mask value ro_ext from the bus interface 110 to the storage circuit 140, and then stored in the corresponding registers (or memory). The first external masked data a′_ext, the second external masked data b′_ext, the first external mask value ra_ext, the second external mask value rb_ext, and the third external mask value ro_ext are provided by the external circuit via the bus 10.

On the other hand, when the selection signal SEL has a second logic level, the selection signal SEL is configured to control the first multiplexer 131, the second multiplexer 133, the third multiplexer 135, the fourth multiplexer 137, and the fifth multiplexer 139 to provide the first internal masked data a′_int and the second internal asked data b′_int, the first internal mask value ra_int, the second internal mask value rb_int, and the third internal mask value ro_int from the mask generator 120 to the storage circuit 140, and then stored in the corresponding registers (or storage devices).

For the secure adder 100, the first internal masked data a′_int, the second internal masked data b′_int, the first internal mask value ra_int, the second internal mask value rb_int, and the third internal mask value ro_int are generated by the mask generator 120. As described above, the generation of the first internal masked data a′_int is related to the first internal mask value ra_int, and the generation of the second internal masked data b′_int is related to the second internal mask value rb_int. On the other hand, for the secure adder 100, the first external masked data a′_ext, the second external masked data b′_ext, the first external mask value ra_ext, the second external mask value rb_ext, and the third external mask value ro_ext are provided by the external circuits. In addition, the generation of the first external masked data a′_ext is related to the first external mask value ra_ext, and the generation of the second external masked data b′_ext is related to the second external mask value rb_ext. In some embodiments, the first external mask value ra_ext is different from the second external mask value rb_ext. In some embodiments, the first external mask value ra_ext is equal to the second external mask value rb_ext.

The storage circuit 140 includes the first register 141, the second register 143, the third register 145, the fourth register 147, and the fifth register 149. The first register 141 is configured to store the first internal masked data a′_int or the first external masked data a′_ext from the multiplexer 131 as the first masked data a′ of the secure carry-lookahead adder 150. In addition, the second register 143 is configured to store the second internal masked data b′_int or the second external masked data b′_ext from the multiplexer 133 as the second external masked data b′ of the secure carry-lookahead adder 150. For the secure carry-lookahead adder 150, the first masked data a′ and the second masked data b′ are masked data.

Furthermore, the register 145 is configured to store the first internal mask value ra_int or the first external mask value ra_ext from the multiplexer 135 as the first mask value ra of the secure carry-lookahead adder 150. The fourth register 147 is configured to store the second internal mask value rb_int or the second external mask value rb_ext from the multiplexer 137 as the second mask value rb of the secure carry-lookahead adder 150. The fifth register 149 is configured to store the third internal mask value ro_int or the third external mask value ro_ext from the multiplexer 139 as the third mask value ro of the secure carry-lookahead adder 150. Next, the secure carry-lookahead adder 150 is configured to generate a carry output Co and a sum output o′ according to the first masked data a′ and the second masked data b′, the first mask value ra, the second mask value rb, and the third mask value ro, and the carry input Cin from the storage circuit 140.

As shown in FIG. 1, the verification circuit 160 includes a first conversion circuit 161, a secure carry-save adder 162, a second conversion circuit 163, and a comparator 164. The verification circuit 160 is configured to verify whether the operation of the secure carry-lookahead adder 150 is correct. The first conversion circuit 161 is configured to convert the first mask value ra into a first conversion variable TV1, and convert the sum output o′ into a second conversion variable TV2.

The secure carry-save adder 162 generates the sum data Sout and the carry data Cout based on the first masked data a′, the second masked data b′, the first mask value ra, the second mask value rb, and the third mask value ro, the first conversion variable TV1, and the second conversion variable TV2. Then, the second conversion circuit 163 converts the sum data Sout and the carry data Cout into the converted sum data ms and the converted carry data mc respectively, and the comparator 164 generates a verification result vf based on the relationship between the converted sum data ms and the converted carry data mc. In some embodiments, the external circuit determines whether the operation of the secure carry-lookahead adder 150 is correct based on the verification result vf.

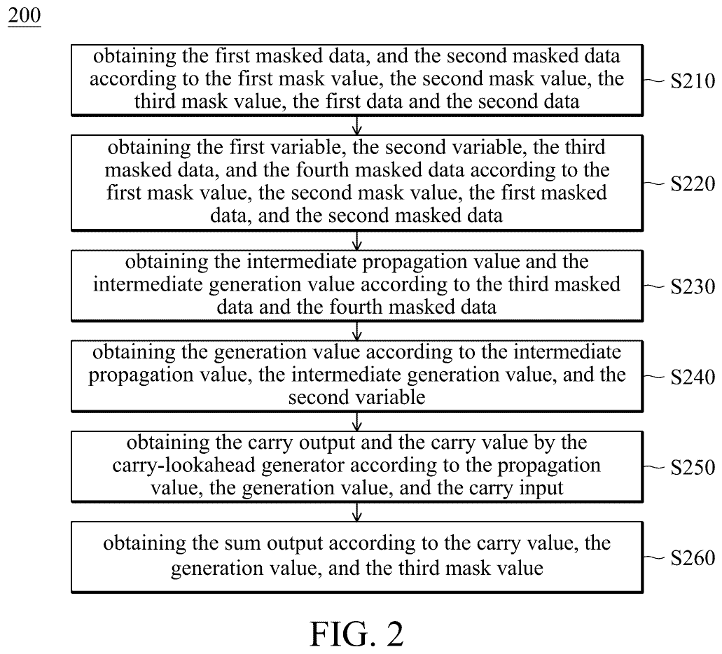

FIG. 2 is a flow chart of a method of performing carry-lookahead addition for the secure carry-lookahead adder 150 of FIG. 1 in accordance with some embodiments of the present invention. In some embodiments, the method of FIG. 2 for performing the carry-lookahead addition may be performed by other circuits (e.g., a processor).

First, in step S210, the first mask value ra, the second mask value rb, the third mask value ro, the first masked data a′, and the second masked data b′ are obtained. As described above, the first masked data a′ is obtained by performing a mask operation (e.g., XOR operation “⊕”) on the first data a with the first mask value ra, as shown in the following equation (1):

$${a}^{′} = a ⊕ r a \qquad ( 1 )$$

Similarly, the second masked data b′ is obtained by performing a mask operation (e.g., XOR operation) on the second data b with the second mask value rb, as shown in the following equation (2):

$${b}^{′} = b ⊕ r b \qquad ( 2 )$$

Furthermore, the third mask value ro is configured to perform a mask operation on the result of the carry-lookahead addition operation, so as to provide security protection for the output, which will be described in detail later.

In step S220, the first variable Rab is obtained according to the first mask value ra and the second mask value rb, as shown in the following equation (3):

$$Rab = ra ⊕ r b \qquad ( 3 )$$

Next, according to the first mask value ra or the second mask value rb, a second variable R is obtained. The following description will be divided into a first type and a second type.

In the first type, the second variable R is equal to the first mask value ra, as shown in the following equation (4):

$$R = r a \qquad ( 4 )$$

Furthermore, the third masked data a″ is obtained according to the first masked data a′, and a mask operation is performed on the second masked data b′ with the first variable Rab, so as to obtain the fourth masked data b″, that are shown in the following equations (5) and (6) respectively:

$${a}^{′′} = {a}^{′} ; and \qquad ( 5 )$$

$${b}^{′′} = {b}^{′} ⊕ Rab . \qquad ( 6 )$$

According to the equations (1) and (4), equation (5), the third masked data a″ is obtained by performing an XOR operation on the first data a and the second variable R, as shown in the following equation (7):

$${a}^{′′} = {a}^{′} = a ⊕ r a = a ⊕ R . \qquad ( 7 )$$

Furthermore, if the second mask value rb is different from the first mask value ra (i.e., rb≠ra), according to the equations (2), (3) and (6), the fourth masked data b″ is obtained by performing an XOR operation on the second data b and the first variable Rab, as shown in the following equation (8):

$$\begin{matrix}{b}^{′′} = {b}^{′} ⊕ R a b = ( b ⊕ r b ) ⊕ ( r a ⊕ r b ) \\ = b ⊕ ra ⊕ ( r b ⊕ r b ) = b ⊕ R\end{matrix} \qquad ( 8 )$$

Conversely, if the second mask value rb is the same as the first mask value ra (i.e., rb=ra), the first variable Rab is equal to 0. Therefore, according to equations (2) and (6), the second mask value rb that is the same as the first mask value ra and the second variable R that is also equal to the first mask value ra, the fourth masked data b″ is obtained by performing an XOR operation on the second data b and the second variable R, as shown in the following equation (9):

$$\begin{matrix}{b}^{′′} = {b}^{′} ⊕ R a b = {b}^{′} ⊕ 0 = {b}^{′} \\ = b ⊕ rb = b ⊕ r a = b ⊕ R\end{matrix} . \qquad ( 9 )$$

From the equations (7), (8) and (9), it can be known that regardless of whether the second mask value rb is the same as the first mask value ra, the fourth masked data b″ is obtained by performing an XOR operation on the second data b and the second variable R. In addition, the original values of the first data a and the second data b will not be revealed during the operation of the equation (3) to the equation (6). In other words, it is not necessary to limit the second mask value rb and the first mask value ra when using the security adder 100 to perform the addition operation. For example, in the conventional security adder, the second mask value rb needs to be restricted from being different from the first mask value ra.

In the second type, the second variable R is equal to the second mask value rb, as shown in the following equation (10):

$$R = r b . \qquad ( 10 )$$

In addition, performing a mask operation on the first masked data a′ according to the first variable Rab, the third masked data a″ can be obtained, and the fourth masked data b″ is obtained according to the second masked data b′, as shown in the following equations (11) and equation (12):

$${a}^{′′} = {a}^{′} ⊕ Rab ; and \qquad ( 11 )$$

$${b}^{′′} = {b}^{′} . \qquad ( 12 )$$

According to the equations (2), (10) and (12), the fourth masked data b″ is obtained by performing an XOR operation on the second data b and the second variable R, as shown in the following equation (13):

$${b}^{′′} = {b}^{′} = b ⊕ r b = b ⊕ R . \qquad ( 13 )$$

Furthermore, if the second mask value rb is different from the first mask value ra (i.e., rb≠ra), according to the equations (1), (3) and (11), the third masked data a″ is obtained by performing an XOR operation equal on the first data a and the first variable Rab, as shown in the following equation (14):

$${a}^{″} = {a}^{′} ⊕ Rab = ( a ⊕ ra ) ⊕ ( ra ⊕ rb ) = a ⊕ rb ⊕ ( ra ⊕ ra ) = a ⊕ R . \qquad ( 14 )$$

Conversely, if the second mask value rb is the same as the first mask value ra (i.e., rb=ra), the first variable Rab is equal to 0. Therefore, according to the equations (2) and (11), the second mask value rb that is the same as the first mask value ra, and the second variable R that is also equal to the second mask value rb, the third masked data a″ is obtained by performing an XOR operation on the first data a and the second variable R, as shown in the following equation (15):

$${a}^{″} = {a}^{′} ⊕ Rab = {a}^{′} ⊕ 0 = {a}^{′} = a ⊕ ra = a ⊕ rb = a ⊕ R . \qquad ( 15 )$$

From the equations (13), (14) and (15), it can be known that regardless of whether the second mask value rb is the same as the first mask value ra, the third masked data a″ is obtained by performing an XOR operation on the first data a and the second variable R. In addition, the original values of the first data a and the second data b will not be revealed during the operation of the equation (3) and the equations (10)-(12). In other words, it is not necessary to limit the second mask value rb and the first mask value ra when using the security adder 100 to perform the addition operation. For example, in the conventional security adder, the second mask value rb needs to be restricted from being different from the first mask value ra.

In step S230, according to the third masked data a″ and the fourth masked data b″ obtained in the first type or the second type, an intermediate propagation value P′ is obtained, as shown in the following equation (16):

$${P}^{′} = {a}^{″} ⊕ {b}^{″} . \qquad ( 16 )$$

Next, according to the equations (7) through (9) of the first type or the equations (13) through (15) of the second type, it is obtained that the intermediate propagation value P′ (i.e., a″⊕b″) of the equation (16) is equal to the propagation value P (i.e., a⊕b), as shown in the following equation (17):

$${P}^{′} = {a}^{″} ⊕ {b}^{″} = ( a ⊕ R ) ⊕ ( b ⊕ R ) = a ⊕ b = P . \qquad ( 17 )$$

In addition, the intermediate generation value G′ is obtained by performing an AND operation (“&”) on the third masked data a″ and the fourth masked data b″, as shown in the following equation (18):

$${G}^{′} = {a}^{″} \& {b}^{″} . \qquad ( 18 )$$

In step S240, according to the distributive property between the AND operation and the XOR operation (e.g., (x⊕y) &z=(x&z)⊕(y&z)), the AND operation of the equation (18) is assigned to the lowest-level operation, as shown in the following equation (19):

$${G}^{′} = {a}^{″} \& {b}^{″} = ( a ⊕ R ) \& ( b ⊕ R ) = ( a \& ( b ⊕ R ) ) ⊕ ( R \& ( b ⊕ R ) ) = ( a \& b ) ⊕ ( a \& R ) ⊕ ( R \& b ) ⊕ ( R \& R ) = ( a \& b ) ⊕ ( a \& R ) ⊕ ( R \& b ) ⊕ R . \qquad ( 19 )$$

Next, for the adder, the AND operation is performed on the first data a and the second data b to obtain the generation value G, i.e., G=a&b. Thus, the equation (19) can be rewritten as the equation (20), as shown below:

$${G}^{′} = ( a \& b ) ⊕ ( a \& R ) ⊕ ( R \& b ) ⊕ R = G ⊕ ( a \& R ) ⊕ ( b \& R ) ⊕ R . \qquad ( 20 )$$

Next, according to the distributive property between AND operation and XOR operation, the equation (20) can be rewritten as the equation (21), as shown below:

$${G}^{′} = G ⊕ ( a \& R ) ⊕ ( b \& R ) ⊕ R = G ⊕ ( ( a ⊕ b ) \& R ) ⊕ R . \qquad ( 21 )$$

Next, the equation (17) is substituted into the equation (21) to obtain the equation (22), as shown below:

$${G}^{′} = G ⊕ ( {P}^{′} \& R ) ⊕ R . \qquad ( 22 )$$

Next, according to the associative property of the XOR operation and the equation (22), the generation value G is obtained according to the equation (23), as shown below:

$$G = {G}^{′} ⊕ ( {P}^{′} \& R ) ⊕ R . \qquad ( 23 )$$

In step S250, according to the propagation value P obtained in the equation (17), the generation value G obtained in the equation (23), and the carry input Cin, the carry-lookahead generator is configured to obtain the carry output Co and the carry value C. The carry-lookahead generator will be described in the following paragraph. In some embodiments, the initial value of the carry input Cin is zero. In some embodiments, the carry input Cin is provided by an external circuit via the bus 10.

In step S260, according to the operation principle of the adder, an XOR operation is performed on the first data a, the second data b, and the carry value C to obtain the sum output o′, as shown in the following equation (24):

$${o}^{′} = ( a + b ) = a ⊕ b ⊕ C = {P}^{′} ⊕ C . \qquad ( 24 )$$

Next, an XOR operation is performed on the sum output o′ and the third mask value ro, so as to satisfy the condition that all the input values and the output values have be masked in the addition operations. Thus, the masked sum output o′ is obtained, as shown in the following equation (25):

$${o}^{′} = ( {P}^{′} ⊕ ro ) ⊕ C . \qquad ( 25 )$$

In general, the carry-lookahead generator can obtain the carry input Co and the carry value C according to the propagation value P, the generation value G and the carry input Cin, as shown in the following equation (26):

$$\{ Co , C \} = CLG ( G , P , Cin . \qquad ( 26 )$$

where CLG is a function of the carry-lookahead generator. Therefore, the equation (27) is obtained by substituting the carry value C of the equation (26) into the equation (25), as shown below:

$${o}^{′} = ( {P}^{′} ⊕ ro ) ⊕ CLG ( G , P , Cin ) . \qquad ( 27 )$$

Next, substituting the generated value G of the equation (23) into the equation (27) can obtain the equation (28), as shown below:

$${o}^{′} = ( {P}^{′} ⊕ ro ) ⊕ CLG ( G , P , Cin ) = ( {P}^{′} ⊕ ro ) ⊕ CLG ( {G}^{′} ⊕ ( {P}^{′} \& R ) ⊕ R , P , Cin ) . \qquad ( 28 )$$

Next, substituting the propagation value P and the intermediate propagation value P′ of the equation (17) into the equation (28) can obtain the equation (29), as shown below:

$${o}^{′} = ( {P}^{′} ⊕ r o ) ⊕ CLG ( {G}^{′} ⊕ ( {P}^{′} \& R ) ⊕ R , P , Cin ) \qquad ( 29 )$$

$$= ( ( {a}^{′′} ⊕ {b}^{′′} ) ⊕ r o ) ⊕ CLG ( {G}^{′} ⊕ ( ( {a}^{′′} ⊕ {b}^{′′} ) \& R ) ⊕ R , ( {a}^{′′} ⊕ {b}^{′′} ) , Cin ) .$$

Next, substitute the intermediate generated value G′ of the equation (18) into the equation (29) to obtain the equation (30), as shown below:

$${o}^{′} = ( {a}^{′′} ⊕ {b}^{′′} ⊕ r o ) ⊕ CLG ( ( ( {a}^{′′} \& {b}^{′′} ) ⊕ ( ( {a}^{′′} ⊕ {b}^{′′} ) \& R ) ⊕ R ) , ( {a}^{′′} ⊕ {b}^{′′} ) , Cin ) \qquad ( 30 )$$

$$= ( {a}^{′′} ⊕ {b}^{′′} ⊕ ro ) ⊕ CLG ( ( ( {a}^{′′} \& {b}^{′′} ) ⊕ R ⊕ ( ( {a}^{′′} ⊕ {b}^{′′} ) \& R ) ) , ( {a}^{′′} ⊕ {b}^{′′} ) , Cin ) .$$

Therefore, the logic circuit of the secure carry-lookahead adder 150 is obtained according to the equation (30), the equation (3) and the equation (7) through equation (9) of the first type or the equation (13) through equation (15) of the second type.

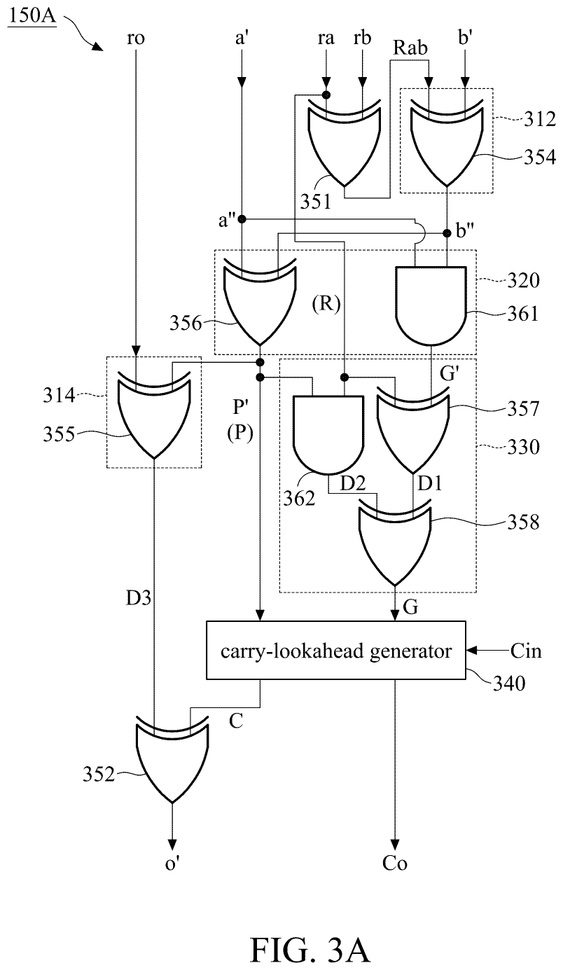

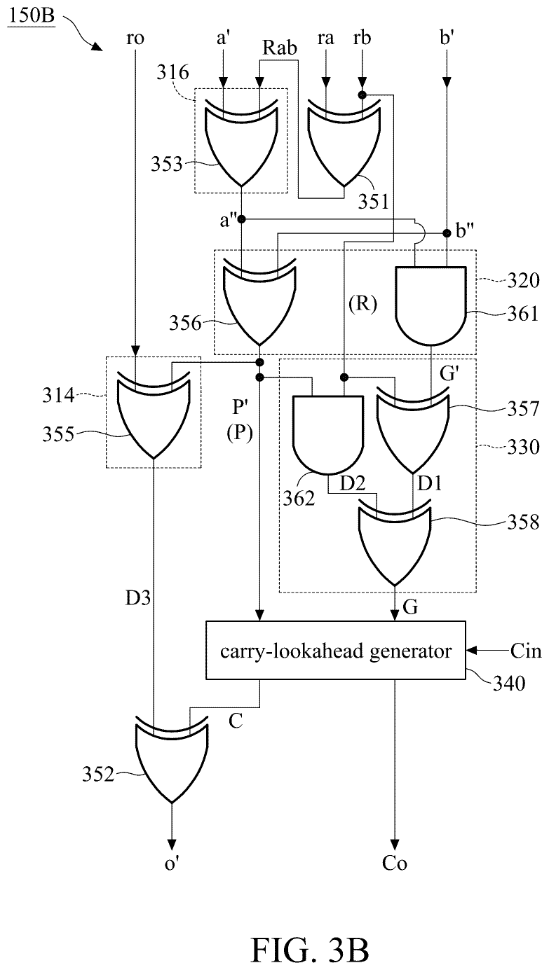

FIG. 3A shows an exemplary circuit of the secure carry-lookahead adder 150A of the first type in accordance with some embodiments of the present invention. The secure carry-lookahead adder 150A includes a second mask unit 312, a third mask unit 314, a half adder 320, a logic circuit 330, a carry-lookahead generator 340, a first XOR gate 351, and a second XOR gate 352.

As shown in the equation (5), the third masked data a″ is equal to the first masked data a′. The first XOR gate 351 is configured to perform an XOR operation on the first mask value ra with the second mask value rb, so as to obtain the first variable Rab, as shown in the equation (2). In addition, the second mask unit 312 includes an fourth XOR gate 354, which is configured to perform a mask operation (i.e., XOR operation) on the second masked data b′ with the first variable Rab, so as to obtain the fourth masked data b″, as shown in the equation (6).

The half adder 320 includes the sixth XOR gate 356 and the first AND gate 361. The sixth XOR gate 356 is configured to receive the third masked data a″ and the fourth masked data b″, and output the intermediate propagation value P′, as shown in the equation (17). As previously described, the intermediate propagation value P′ (i.e., x″⊕y″) is equal to the propagation value P (i.e., x⊕y). Moreover, the first AND gate 361 is configured to receive the third masked data a″ and the fourth masked data b″, and output an intermediate generation value G′, as shown in the equation (18).

The first logic circuit 330 is configured to provide the generation value G according to the second variable R, the intermediate generation value G′, and the intermediate propagation value P′ (i.e., the propagation value P). In some embodiments, first logic circuit 330 includes the seventh XOR gate 357, the eighth XOR gate 358, and the second AND gate 362. The seventh XOR gate 357 is configured to receive the second variable R and the intermediate generation value G′, and output the first intermediate data D1. The second AND gate 362 is configured to receive the second variable R and the intermediation propagation value P′ (i.e., the propagation value P), and output the intermediate data D2. Additionally, the eighth XOR gate 358 is configured to receive the first intermediate data D1 and the second intermediate data D2 and output the generation value G to the carry-lookahead generator 340. Thus, the carry-lookahead generator 340 is configured to obtain the carry output Co and the carry value C according to the propagation value P (i.e., the intermediate propagation value P′), the generation value G, and the carry input Cin. The operation of the carry-lookahead generator 340 will be described in the following paragraphs.

The third mask unit 314 includes an fifth XOR gate 355 that is configured to perform a mask operation on the intermediate propagation value P′ (i.e., the propagation value P) with the third mask value ro, so as to obtain the third intermediate data D3. It should be noted that due to longer delay in the delivery path within the carry-lookahead generator 340, the third mask value ro is used to perform a mask operation on the intermediate propagation value P′ through the third mask unit 314. Next, the second XOR gate 352 is configured to receive the third intermediate data D3 and the carry value C and provide the sum output o′.

After obtaining the sum output o′, the secure carry-lookahead adder 150A is configured to provide the sum output o′ and the carry output Co to the bus interface 110, so as to provide to other circuits (e.g., processors) via the bus 10 for subsequent operations. As described above, the sum output o′ is the masked data. Therefore, in addition to providing the sum output o′ and the carry output Co, the secure adder 100 is configured to further provide the third mask value ro to other circuits. Therefore, other circuits can use the third mask value ro to remove the mask of the sum output o′, so as to obtain the original value of the sum output o′.

FIG. 3B shows an exemplary circuit of the secure carry-lookahead adder 150B of the second type in accordance with some embodiments of the present invention. The secure carry-lookahead adder 150B includes a third mask unit 310, a fourth mask unit 314, a half adder 320, a logic circuit 330, a carry-lookahead generator 340, a first XOR gate 351, and a second XOR gate 352.

In FIG. 3B, the fourth masked data b″ is equal to the second masked data b′, as shown in the equation (12). In addition, the fourth mask unit 316 includes a third XOR gate 353 configured to perform a mask operation (i.e., an XOR operation) on the first masked data a′ according to the first variable Rab, so as to obtain the third masked data a″, as shown in the equation (11).

Similar to FIG. 3A, the half adder 320 is configured to output an intermediate propagation value P′ (the propagation value P) and an intermediate generated value G′ according to the third masked data a″ and the fourth masked data b″. Next, the first logic circuit 330 is configured to output the generated value G according to the second variable R, the intermediate generated value G′ and the intermediate propagation value P′. Next, the carry-lookahead generator 340 is configured to obtain a carry output Co and a carry value C according to the propagation value P (i.e., the intermediate propagation value P′), the generated value G, and the carry input Cin. As previously described, the second XOR gate 352 is configured to receive carry value C and third intermediate data D3 from the third mask unit 314, and provide a sum output o′.

After obtaining the sum output o′, the secure carry-lookahead adder 150B is configured to provide the sum output o′ and the carry output Co to the bus interface 110, so as to provide to other circuits (such as processors) via the bus 10 for subsequent operations. As previously described, the sum output o′ is the masked data. Therefore, in addition to providing the sum output o′ and the carry output Co, the secure adder 100 is configured to further provide the third mask value ro to other circuits. Thus, other circuits can use the third mask value ro to remove the mask of the sum output o′ to obtain the original value of the sum output o′.

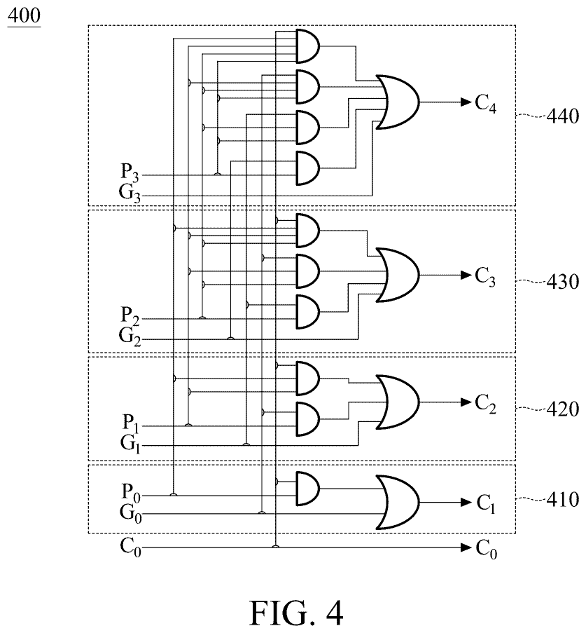

FIG. 4 is a schematic diagram of a 4-bit carry-lookahead generator 400 illustrating the carry-lookahead generator 340 of FIGS. 3A and 3B in accordance with some embodiments of the present invention. In such embodiments, the propagation value P is 4-bit data consisting of the propagation signals (or bits) P₃, P₂, P₁ and P₀, i.e., P=[P₃, P₂, P₁, P₀], where P₃ is the most significant bit (MSB) and P₀ is the least significant bit (LSB). The generation value G is 4-bit data consisting of the generation signals (or bits) G₃, G₂, G₁ and G₀, i.e., G=[G₃, G₂, G₁, G₀], where G₃ is the most significant bit and G₀ is the least significant bit.

In addition, the input signal (or bit) Co is 1-bit data composed of the carry input Cin, i.e., C₀=Cin. According to the propagation value P, the generation value G, and the carry input Cin, the carry-lookahead generator 400 is configured to perform the operations of equations (31) to (34) to obtain the carry output C₀ and the carry value C. The carry value C is 4-bit data composed of output signals (or bits) C₃, C₂, and C₁, and the input signal C₀, i.e., C=[C₃, C₂, C₁, C₀], where C₃ is the most significant bit and C₀ is the least significant bit. In addition, the carry output C₀ is determined by the output signal (or bit) C₄, i.e., C₀=C₄. Equations (31) to (34) are shown below:

$${C}_{1} = {G}_{0} \vert {P}_{0} \& {C}_{0} ; \qquad ( 31 )$$

$${C}_{2} = {G}_{1} \vert {P}_{1} \& {G}_{0} \vert {P}_{1} \& {P}_{0} \& {C}_{0} ; \qquad ( 32 )$$

$${C}_{3} = {G}_{2} \vert {P}_{2} \& {G}_{1} \vert {P}_{2} \& {P}_{1} \& {G}_{0} \vert {P}_{2} \& {P}_{1} \& {P}_{0} \& {C}_{0} ; and \qquad ( 33 )$$

$${C}_{4} = {G}_{3} \vert {P}_{3} \& {G}_{2} \vert {P}_{3} \& {P}_{2} \& {G}_{1} \vert {P}_{3} \& {P}_{2} \& {P}_{1} \& {G}_{0} \vert {P}_{3} \& {P}_{2} \& {P}_{1} \& {P}_{0} \& Co \qquad ( 34 )$$

As described above, “|” means to perform an OR operation, and “&” means to perform an AND operation.

The carry-lookahead generator 400 includes the a second logic circuit 410, a third logic circuit 420, a fourth logic circuit 430, and a fifth logic circuit 440. The second logic circuit 410 is configured to perform the operation of equation (31) to generate the output signal C₁ according to the input signal C₀, the generation signal G₀ and the propagation signal P₀. The third logic circuit 420 is configured to perform the operation of equation (32) to generate the output signal C₂ according to the input signal C₀, the generation signals G₀ and G₁, and the propagation signals P₀ and P₁.

Furthermore, the fourth logic circuit 430 is configured to perform the operation of equation (33) to generate the output signal C₃ according to the input signal C₀, the generation signals G₀ through G₂, and the propagation signals P₀ through P₂. The logic circuit 440 is configured to perform the operation of equation (34) to generate the output signal C₄ according to the input signal C₀, the generation signals G₀ through G₃, and the propagation signals P₀ through P₃. It should be noted that the 4-bit carry-lookahead generator 400 is only an example, and is not intended to limit the present invention. More-bit or less-bit carry-lookahead generator can be used in the secure adder of the present invention. Moreover, the number of bits of the carry value C generated by the carry-lookahead generator 400 is the same as the number of bits of the propagation value P and the generation value G, and the number of bits of the carry output C₀ is one bit.

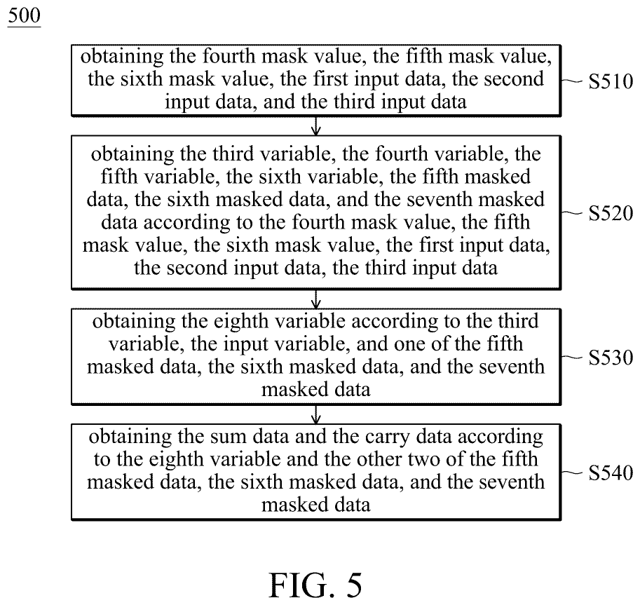

FIG. 5 is a flowchart showing a method of performing a secure carry-save addition according to some embodiments of the present invention, which is applicable to the secure carry-save adder 162 of FIG. 1. In some embodiments, the method 500 for performing secure carry-save addition in FIG. 5 may be performed by other circuits (e.g., a processor).

First, in step S510, the fourth mask value rx, the fifth mask value ry, the sixth mask value rz, the first input data x′, the second input data y′, and the third input data z′ are obtained, where the first input data x′ is obtained by performing a mask operation on the third data x using the fourth mask value rx, as shown in the following equation (35):

$${x}^{′} = x ⊕ rx . \qquad ( 35 )$$

Similarly, the second input data y′ is obtained by performing a mask operation on the fourth data y using the fifth mask value ry, as shown in the following equation (36):

$${y}^{′} = y ⊕ ry . \qquad ( 36 )$$

Furthermore, the third input data z′ is obtained by performing a mask operation on the fifth data z using the sixth mask value rz, as shown in the following equation (37):

$${z}^{′} = z ⊕ rz . \qquad ( 37 )$$

In step S520, the third variable Rr can be obtained according to the fourth mask value rx, the fifth mask value ry, or the sixth mask value rz. For example, the third variable Rr may be equal to the fourth mask value rx, the fifth mask value ry, or the sixth mask value rz. In this embodiment, the third variable Rr is equal to the fourth mask value rx, as shown in the following equation (38):

$$Rr = rx . \qquad ( 38 )$$

Furthermore, the fourth variable Rxy and the fifth variable Rxz can be obtained according to the fourth mask value rx, the fifth mask value ry and the sixth mask value rz, as shown in the following equations (39) and (40) Shown:

$$Rxy = rx ⊕ ry ; and \qquad ( 39 )$$

$$Rxz = rx ⊕ rz . \qquad ( 40 )$$

In some embodiments, when the third variable Rr is equal to the fifth mask value ry, the fourth variable Rxy and the sixth variable Ryz can be obtained according to the fourth mask value rx, the fifth mask value ry, and the sixth mask value rz, where Ryz=ry⊕rz. In some embodiments, when the third variable Rr is equal to the sixth mask value rz, the fifth variable Rxz and the sixth variable Ryz can be obtained according to the fourth mask value rx, the fifth mask value ry, and the sixth mask value rz, where Rxz=rx⊕rz.

When the third variable Rr is equal to the fourth mask value rx, the fifth masked data x″ can be obtained according to the first input data x′, as shown in the following equation (41).

$${x}^{′′} = {x}^{′} . \qquad ( 41 )$$

In addition, the mask operation is performed on the second input data y′ and the third input data z′ respectively according to the fourth variable Rxy and the fifth variable Rxz, so as to obtain the sixth masked data y″ and the seventh masked data z″, which are shown in the following equations (42) and (43) respectively:

$${y}^{′′} = {y}^{′} ⊕ Rxy ; and \qquad ( 42 )$$

$${z}^{′′} = {z}^{′} ⊕ Rxz . \qquad ( 43 )$$

According to equation (35) and equation (42), it can be seen that the fifth masked data x″ is equal to a result of performing the XOR operation on the third data x and the third variable Rr, as shown in the following equation (44):

$${x}^{′′} = {x}^{′} = x ⊕ r x = x ⊕ R r . \qquad ( 44 )$$

In addition, if the fifth mask value ry is different from the fourth mask value rx (i.e. ry⊕rx), then it can be seen that the sixth masked data y″ is equal to a result of performing the XOR operation on the fourth data y and the third variable Rr according to equation (36), equation (38) and equation (39), as shown in the following equation (45):

$${y}^{′′} = {y}^{′} ⊕ R x y = ( y ⊕ r y ) ⊕ ( r x ⊕ ry ) \qquad ( 45 )$$

$$= y ⊕ r x ⊕ ( r y ⊕ r y ) = y ⊕ Rr .$$

On the contrary, if the fifth mask value ry is the same as the fourth mask value rx (that is, ry=rx), then the fourth variable Rxy is equal to 0. Therefore, according to equations (36) and (39), the fifth mask value ry is the same as the fourth mask value rx, and the third variable Rr is also equal to the fourth mask value rx. It can be seen that the sixth masked data y″ is equal to a result of performing the XOR operation on the fourth data y and the third variable Rr, as shown in the following equation (46):

$${y}^{′′} = {y}^{′} ⊕ R x y = {y}^{′} ⊕ 0 = {y}^{′} \qquad ( 46 )$$

$$= y ⊕ r y = y ⊕ r x = y ⊕ Rr .$$

It can be seen from equations (45) and (46) that no matter whether the fifth mask value ry is the same as the fourth mask value rx, the sixth masked data y″ is equal to a result of performing the XOR operation on the fourth data y and the third variable Rr. In addition, the original values of the third data x and the fourth data y will not be revealed during the operation of equations (44) to (46). In other words, using the secure carry-save adder 162 to perform the addition operation does not require restrictions on the fifth mask value ry and the fourth mask value rx.

Similarly, if the sixth mask value rz is different from the fourth mask value rx (i.e. rz≠rx), then according to equation (37), equation (38), and equation (40), it can be seen that the seventh masked data z″ is equal to a result of performing the XOR operation on the fifth data z and the third variable Rr, as shown in the following equation (47):

$${z}^{′′} = {z}^{′} ⊕ R x z = ( z ⊕ r z ) ⊕ ( r x ⊕ rz ) \qquad ( 47 )$$

$$= z ⊕ r x ⊕ ( r z ⊕ r z ) = z ⊕ Rr .$$

On the contrary, when the sixth mask value rz is the same as the fourth mask value rx (that is, rz=rx), then the fifth variable Rxz is equal to 0. Therefore, according to equations (37) and (40), the sixth mask value rz is the same as the fourth mask value rx, and the third variable Rr is also equal to the fourth mask value rx. It can be seen that the seventh masked data z″ is equal to a result of performing the XOR operation on the fifth data z and the third variable Rr, as shown in the following equation (48):

$${z}^{′′} = {z}^{′} ⊕ R x z = {z}^{′} ⊕ 0 = {z}^{′} \qquad ( 48 )$$

$$= z ⊕ r z = z ⊕ r x = z ⊕ Rr .$$

It can be seen from equations (47) and (48) that no matter whether the sixth mask value rz is the same as the fourth mask value rx, the seventh masked data z″ is equal to the result of performing the XOR operation on the fifth data z and the third variable Rr. In addition, the original values of the third data x and the fifth data z will not be revealed during the operation of equation (44), equation (47), and equation (48). In other words, using the secure carry-save adder 162 to perform the addition operation does not require restrictions on the sixth mask value rz and the fourth mask value rx.

The carry-save adder mainly compresses the three data x, y and z into two original output values sum and carry (i.e., the original values that are not masked), as shown in the following equation (49) and equation (50) Shown:

$$sum = x ⊕ y ⊕ z ; and \qquad ( 49 )$$

$$carry = ( x \& y ) \vert ( x \& z ) \vert ( y \& z ) . \qquad ( 50 )$$

As shown in equations (49) and (50), “|” represents an OR operation, and “&” represents an AND operation.

It is assumed that the masked data sum” can be obtained by performing the XOR operation on the fifth masked data x″, the sixth masked data y″, and the seventh masked data z″, which is shown in the following equation (51):

$${sum}^{″} = {x}^{″} ⊕ {y}^{″} ⊕ {z}^{″} . \qquad ( 51 )$$

Next, by substituting equations (44)-(49) into equation (51), equation (52) can be obtained and rewritten into equation (53), which is shown as below:

$$\begin{matrix}{sum}^{″} = ( x ⊕ Rr ) ⊕ ( y ⊕ Rr ) ⊕ ( x ⊕ Rr ) \\ = ( x ⊕ y ⊕ z ) ⊕ Rr \\ = sum ⊕ Rr\end{matrix} . \qquad ( 52 )$$

$$sum = {sum}^{″} ⊕ Rr . \qquad ( 53 )$$

Similarly, it is assumed that the masked data carry″ can be obtained by performing OR operations and AND operations on the fifth masked data x″, the sixth masked data y″, and the seventh masked data z″, as shown in the following equation (54):

$${carry}^{″} = ( {x}^{″} \& {y}^{″} ) \vert ( {x}^{″} \& {z}^{″} ) \vert ( {y}^{″} \& {z}^{″} ) . \qquad ( 54 )$$

Next, by substituting equations (44)-(49) into equation (54), equation (55) can be obtained, as shown below:

$${carry}^{″} = ( ( x ⊕ Rr ) \& ( y ⊕ Rr ) ) \vert ( ( x ⊕ Rr ) \& ( z ⊕ Rr ) ) \vert ( ( y ⊕ Rr ) \& ( z ⊕ Rr ) ) . \qquad ( 55 )$$

Next, the equation (55) is rewritten into the equation (56) according to the distributive property between the AND operation and the XOR operation, as shown below:

$${carry}^{″} = ( ( x \& y ) ⊕ ( ( x ⊕ y ) \& Rr ) ⊕ Rr ) \vert ( ( x \& z ) ⊕ ( ( x ⊕ z ) \& Rr ) ⊕ Rr ) \vert ( ( y \& z ) ⊕ ( ( y ⊕ z ) \& Rr ) ⊕ Rr ) . \qquad ( 56 )$$

In order to simplify the equations, new variables Exy, Eyz and Exz are defined as shown in the following calculation formulas (57)-(59):

$$Exy = ( ( x ⊕ y ) \& Rr ) ⊕ Rr ; \qquad ( 57 )$$

$$Exz = ( ( x ⊕ z ) \& Rr ) ⊕ Rr ; \qquad ( 58 )$$

$$Eyz = ( ( y ⊕ z ) \& Rr ) ⊕ Rr ; \qquad ( 59 )$$

Next, by substituting the variables Exy, Eyz, and Exz into the equation (56), the equation (60) can be obtained, as shown below:

$${carry}^{″} = ( ( x \& y ) ⊕ Exy ) \vert ( ( x \& z ) ⊕ Exz ) \vert ( ( y \& z ) ⊕ Eyz ) . \qquad ( 60 )$$

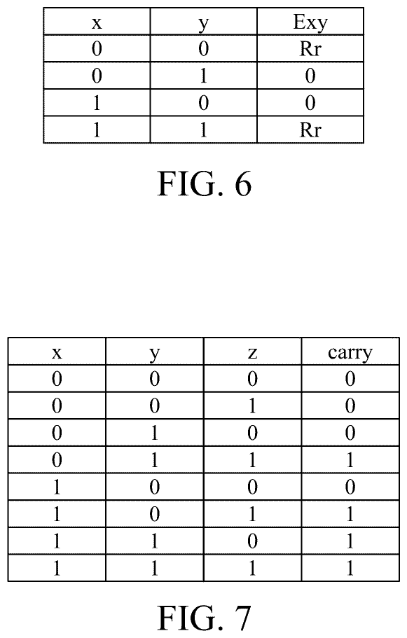

Referring to FIG. 6, FIG. 6 shows a truth table of the variable Exy in accordance with some embodiments of the present invention. As shown in FIG. 6, when the third data x and the fourth data y are equal, the variable Exy is equal to the Rr. On the contrary, when the third data x is different from the fourth data y, the variable Exy is equal to 0. Similarly, when the third data x and the fifth data z are equal, the variable Exz is equal to the Rr. On the contrary, when the third data x is different from the fifth data z, the variable Exz is equal to 0. Furthermore, when the fourth data y and the fifth data z are equal, the variable Eyz is equal to the Rr. On the contrary, when the fourth data y is different from the fifth data z, the variable Eyz is equal to 0.

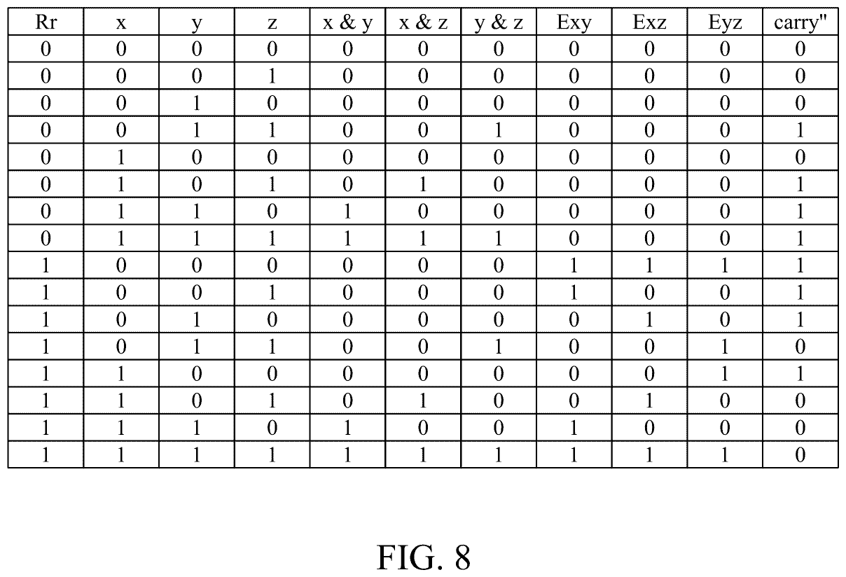

FIG. 7 is a truth table showing the original output value carry of equation (50) in accordance with some embodiments of the present invention, and FIG. 8 is a truth table showing the masked data carry″ of equation (60) in accordance with some embodiments of the present invention. Referring to FIGS. 7 and 8 at the same time, when the third variable Rr is equal to 0, no matter what the values of the third data x, the fourth data y, and the fifth data z are, the value of the masked data carry″ is the same as the original output value carry. On the contrary, when the third variable Rr is equal to 1, no matter what the values of the third data x, the fourth data y, and the fifth data z are, the value of the masked data carry″ is opposite (or complementary) to the original output value carry. Therefore, the following equation (61) can be derived from FIGS. 7 and 8:

$$carry = {carry}^{″} ⊕ Rr . \qquad ( 61 )$$

Next, the mask values of the original output value sum and the original output value carry are set as the input variable Rsum and the mask value Rcarry respectively. Furthermore, in order to optimize the secure carry-save adder, the mask value Rcarry is set to be the third variable Rr. In addition, the mask value Rcarry and the input variable Rsum can be used to perform mask operations on the original output value carry and the original output value sum respectively to obtain the carry data Cout and the sum data Sout, as shown in the following equations (62) to (63):

$$\begin{matrix}Sout = sum ⊕ Rsum = {sum}^{″} ⊕ Rr ⊕ Rsum \\ = {x}^{″} ⊕ {y}^{″} ⊕ {z}^{″} Rr ⊕ Rsum ; and\end{matrix} \qquad ( 62 )$$

$$\begin{matrix}Cout = carry ⊕ R carry = {carry}^{″} ⊕ Rr ⊕ R carry \\ = {carry}^{″}\end{matrix} \qquad ( 63 )$$

Since the mask value Rcarry is equal to the third variable Rr, the equation (63) can be optimized to Cout=carry″. Furthermore, the seventh variable Rsum′ can be obtained by performing the XOR operation on the third variable Rr and the input variable Rsum, as shown in the following equation (64):

$${Rsum}^{′} = ( Rr ⊕ Rsum ) . \qquad ( 64 )$$

Next, the XOR operation is performed on the fifth masked data x″ and the seventh variable Rsum′ to obtain the eighth variable Rsum″, as shown in the following equation (65):

$${Rsum}^{′} = ( {x}^{″} ⊕ {Rsum}^{′} ) . \qquad ( 65 )$$

Therefore, by substituting equation (64) and equation (65) into equation (62), equation (66) can be obtained, as shown below:

$$Sout = {y}^{″} ⊕ {z}^{″} ⊕ {Rsum}^{″} . \qquad ( 66 )$$

Referring to FIG. 5, in step S530, according to one of the fifth masked data x″, the sixth masked data y″, and the seventh masked data z″ (for example, the fifth masked data x″), the third variable Rr, and the input variable Rsum, the eighth variable Rsum″ can be obtained as shown in equation (64) and equation (65). Next, in step S540, according to the other two of the fifth masked data x″, the sixth masked data y″, and the seventh masked data z″ (for example, the sixth masked data y″ and the seventh masked data z″) and the eighth variable Rsum″, the sum data Sout and the carry data Cout can be obtained as shown in equations (63) and (66).

It is noted that in this embodiment, the third variable Rr is equal to the fourth mask value rx. According to the sixth masked data y″, the seventh masked data z″, and the eighth variable Rsum″ the sum data Sout can be obtained as shown in equation (66). In addition, the eighth variable Rsum″ is obtained based on the fifth masked data x″, as shown in equation (65). Therefore, according to equations (44)-(48), equation (52), equation (54), equation (63), equation (64), equation (65), and equation (66), the logic circuit of the secure carry-save adder 162 can be obtained.

In some embodiments, the third variable Rr is equal to the fifth mask value ry. According to the fifth masked data x″, the seventh masked data z″, and the eighth variable Rsum″, the sum data Sout can be obtained, as shown in the following equation (67):

$$Sout = {x}^{″} ⊕ {z}^{″} ⊕ {Rsum}^{″} . \qquad ( 67 )$$

In addition, the eighth variable Rsum″ is obtained based on the sixth masked data y″, as shown in the following equation (68):

$${Rsum}^{″} = ( {y}^{″} ⊕ {Rsum}^{′} ) . \qquad ( 68 )$$

In some embodiments, the third variable Rr is equal to the sixth mask value rz, so that the sum data Sout can be obtained according to the fifth masked data x″ and y″ and the eighth variable Rsum″, as shown in the following equation (69):

$$Sout = {x}^{″} ⊕ {y}^{″} ⊕ {Rsum}^{″} . \qquad ( 69 )$$

In addition, the eighth variable Rsum″ is obtained based on the seventh masked data z″, as shown in the following equation (70):

$${Rsum}^{″} = ( {z}^{″} ⊕ {Rsum}^{′} ) . \qquad ( 70 )$$

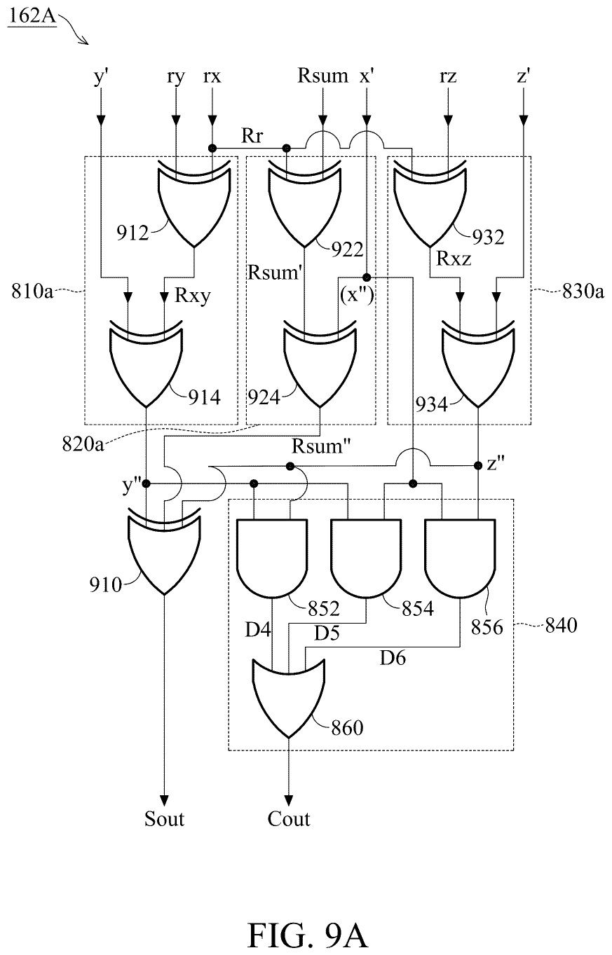

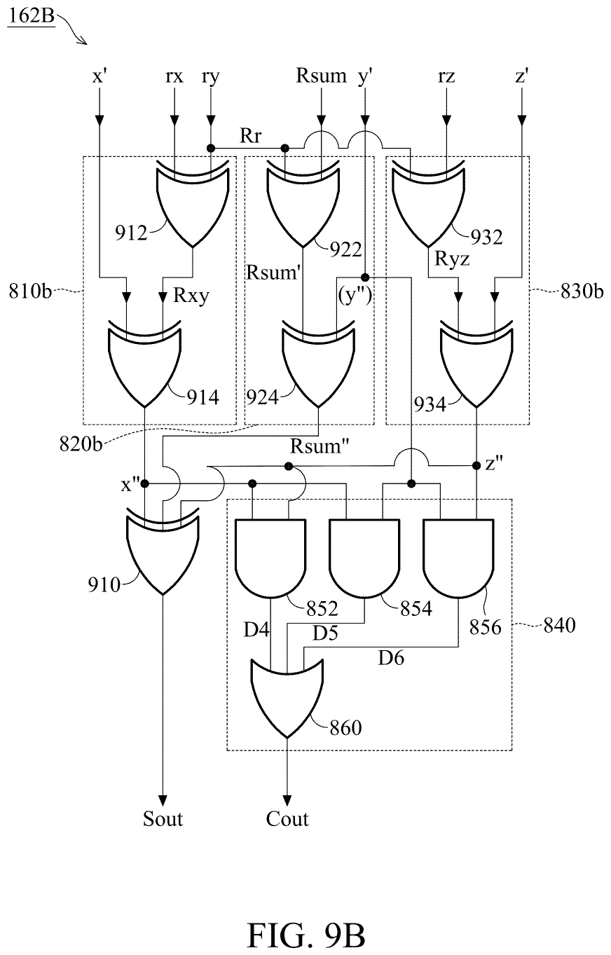

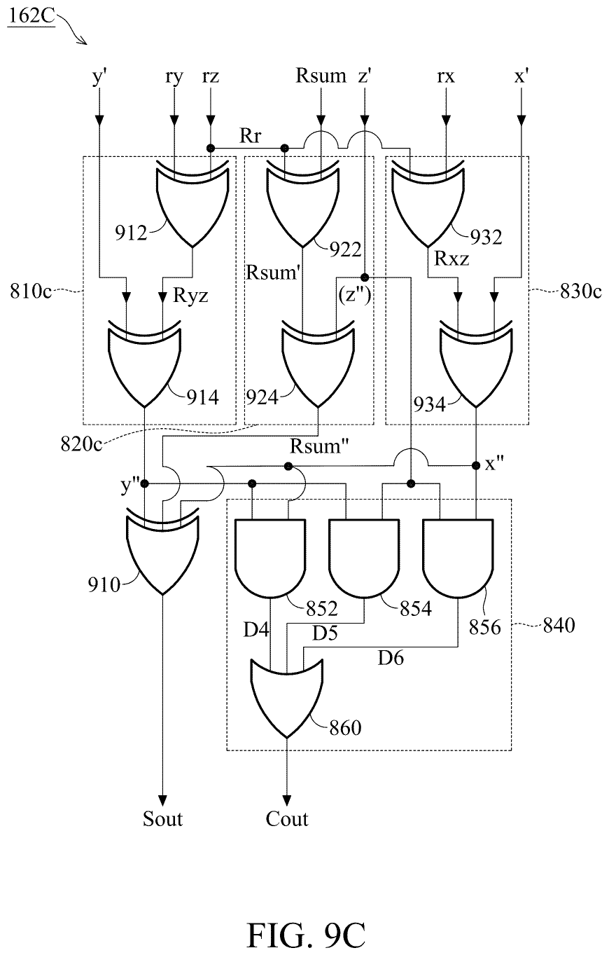

FIG. 9A is an exemplary circuit diagram showing a secure carry-save adder 162A in accordance with some embodiments of the present invention. The secure carry-save adder 162A includes a fifth mask unit 810a, a sixth mask unit 820a, a seventh mask unit 830a, a sixth logic circuit 840, and a ninth XOR gate 910. In this embodiment, the third variable Rr is equal to the fourth mask value rx.

The fifth mask unit 810a is configured to perform a mask operation on the second input data y′ according to the fourth mask value rx and the fifth mask value ry to obtain the sixth masked data y″. In some embodiments, the fifth mask unit 810a includes a tenth XOR gate 912 and an eleventh XOR gate 914. The tenth XOR gate 912 is used to perform the XOR operation on the fifth mask value ry and the fourth mask value rx to obtain the fourth variable Rxy, as shown in equation (5). Next, the eleventh XOR gate 914 is configured to perform a mask operation (i.e., the XOR operation) on the second input data y′ according to the fourth variable Rxy, so as to obtain the sixth masked data y″, as shown in equation (42).

The sixth mask unit 820a is configured to perform a mask operation on the first input data x′ according to the fourth mask value rx (i.e., the third variable Rr) and the input variable (or mask value) Rsum to obtain the eighth variable Rsum″, and the eighth variable Rsum″ can also be regarded as masked data. In some embodiments, the sixth mask unit 820a includes a twelfth XOR gate 922 and a thirteenth XOR gate 924. The twelfth XOR gate 922 is used to perform the XOR operation on the third variable Rr (i.e., the fourth mask value rx) and the input variable Rsum to obtain the seventh variable Rsum′, as shown in equation (64). Next, the thirteenth XOR gate 924 is configured to perform a mask operation on the fifth masked data x″ (i.e., the first input data x′) according to the seventh variable Rsum′, so as to obtain the eighth variable Rsum″, as shown in equation (65).

The seventh mask unit 830a is configured to perform a mask operation on the third input data z′ according to the fourth mask value rx and the sixth mask value rz, to obtain the seventh masked data z″. In some embodiments, the seventh mask unit 830a includes a fourteenth XOR gate 932 and a fifteenth XOR gate 934. The fourteenth XOR gate 932 is used to perform the XOR operation on the fourth mask value rx and the sixth mask value rz to obtain the fifth variable Rxz, as shown in equation (40). Next, the fifteenth exclusive OR gate 934 is configured to perform a mask operation on the third input data z′ according to the fifth variable Rxz, so as to obtain the seventh masked data z″, which is shown in equation (43).

The sixth logic circuit 840 provides carry data Cout based on the fifth masked data x″, the sixth masked data y″, and the seventh masked data z″. In some embodiments, the sixth logic circuit 840 includes a third AND gate 852, a fourth AND gate 854, a fifth AND gate 856, and an OR gate 860. The third AND gate 852 is configured to receive the sixth masked data y″ and the seventh masked data z″, and output the fourth intermediate data D4. In addition, the fourth AND gate 854 is configured to receive the sixth masked data y″ and the fifth masked data x″, and output the fifth intermediate data D5. Furthermore, the fifth AND gate 856 is configured to receive the seventh masked data z″ and the fifth masked data x″, and output the sixth intermediate data D6. The OR gate 860 is configured to receive the fourth intermediate data D4, the fifth intermediate data D5, and the sixth intermediate data D6, and output the carry data Cout, as shown in equations (54) and (63).

The ninth XOR gate 910 is configured to receive the sixth masked data y″, the seventh masked data z″ and the eighth variable Rsum″, and output the sum data Sout, as shown in the equation (66). Therefore, the secure carry-save adder 162 performs the addition operation on the three input data x′, y′ and z′ without removing the fourth mask value rx, the fifth mask value ry, and the sixth mask value rz, and provides sum data Sout and carry data Cout.

FIG. 9B is an exemplary circuit diagram showing a secure carry-save adder 162B in accordance with some embodiments of the present invention. The secure carry-save adder 162B includes a fifth mask unit 810b, a sixth mask unit 820b, a seventh mask unit 830b, a sixth logic circuit 840, and a ninth XOR gate 910. In this embodiment, the third variable Rr is equal to the fifth mask value ry.

In FIG. 9B, the fifth mask unit 810b is configured to perform a mask operation on the first input data x′ according to the fourth mask value rx and the fifth mask value ry to obtain the fifth masked Cover data x″. In addition, the sixth masking unit 820b is configured to perform a masking operation on the second input data y′ according to the fifth mask value ry (i.e., the third variable Rr) and the input variable Rsum to obtain the eighth variable Rsum″. Furthermore, the seventh mask unit 830b is configured to perform a mask operation on the third input data z′ according to the fifth mask value ry and the sixth mask value rz, to obtain the seventh masked data z″.

Similar to FIG. 9A, the sixth logic circuit 840 of the secure carry-save adder 162B provides carry data Cout according to the fifth masked data x″, the sixth masked data y″ and the seventh masked data z″. In addition, the ninth XOR gate 910 of the secure carry-save adder 162B is configured to receive the fifth masked data x″, the seventh masked data z″, and the eighth variable Rsum″, and output the sum data Sout as shown in equation (67).

FIG. 9C is an exemplary circuit diagram showing a secure carry-save adder 162C in accordance with some embodiments of the present invention. The secure carry-save adder 162C includes a fifth mask unit 810c, a sixth mask unit 820c, a seventh mask unit 830c, a sixth logic circuit 840, and a ninth XOR gate 910. In this embodiment, the third variable Rr is equal to the sixth mask value rz.

In FIG. 9C, the fifth mask unit 810c is configured to perform a mask operation on the second input data y′ according to the fifth mask value ry and the sixth mask value rz, to obtain the sixth masked data y″. In addition, the sixth mask unit 820c is configured to perform a mask operation on the third input data z′ according to the sixth mask value rz (i.e., the third variable Rr) and the input variable Rsum to obtain the eighth variable Rsum″. Furthermore, the seventh mask unit 830c is configured to perform a mask operation on the first input data x′ according to the fourth mask value rx and the sixth mask value rz to obtain the fifth masked data x″.

Similar to FIG. 9A, the sixth logic circuit 840 of the secure carry-save adder 162C provide carry data Cout according to the fifth masked data x″, the sixth masked data y″ and the seventh masked data z″. In addition, the ninth XOR gate 910 of the secure carry-save adder 162C is configured to receive the sixth masked data y″, the seventh masked data z″ and the eighth variable Rsum″, and output the sum data Sout as shown in equation (69).

Referring to FIG. 1, the secure carry-save adder 162 is used to verify whether the secure addition operation performed by the secure carry-lookahead adder 150 is correct. How the verification circuit 160 verifies the result of the operation performed by the secure carry-lookahead adder 150 will be described in detail below.

The secure addition operation performed by the secure carry-lookahead adder 150 is shown in equation (71) and equation (72):

$$\begin{matrix}{a}^{′} = ( a ⊕ ra ) \\ {b}^{′} = ( b ⊕ rb ) \\ {o}^{′} = ( o ⊕ ro )\end{matrix} ; \qquad ( 71 )$$

$$( {o}^{′} ⊕ ro ) = ( {a}^{′} ⊕ ra ) + ( {b}^{′} ⊕ rb ) . \qquad ( 72 )$$

Equation (71) and equation (72) can be simplified as Equation (73):

$$SCLA ( {a}^{′} , {b}^{′} , ra , rb , ro ) = {o}^{′} . \qquad ( 73 )$$

SCLA is used to represent the secure addition operation performed by the secure carry-lookahead adder 150. The secure addition operation performed by the secure carry-save adder 162 is as shown in equation (74) and equation (75):

$$\begin{matrix}{x}^{′} = ( x ⊕ rx ) \\ {y}^{′} = ( y ⊕ ry ) \\ {z}^{′} = ( z ⊕ rz ) \\ Sout = ( Sum ⊕ Rsum ) \\ Cout = ( carry ⊕ rx )\end{matrix} ; \qquad ( 74 )$$

$$( Sout ⊕ Rsum ) + ( Cout ⊕ rx ) ≪ 1 = ( {x}^{′} ⊕ rx ) + ( {y}^{′} ⊕ ry ) + ( {z}^{′} ⊕ rz ) . \qquad ( 75 )$$

The fourth mask value rx is used for the original output value carry as the optimized result, and <<1 is used to represent (Cout⊕rx) left-shifted by one bit. In addition, equation (74) and equation (75) can be combined into equation (76), where SCSA is used to represent the secure addition operation performed by the secure carry-save adder 162.

$$SCSA ( {x}^{′} , {y}^{′} , {z}^{′} , rx , ry , rz , Rsum ) = ( Sout , Cout ≪ 1 ) . \qquad ( 76 )$$

Equation (77) uses 2's complement representation to express the inverse value, where M is an arbitrary value, and ˜M is the inverse of M.

$$- M = \sim M + 1. \qquad ( 77 )$$

Suppose M is k bits, and the reverse value of M is equal to a result of performing XOR mask on M and {k {1}} values, which is shown in equation (78).

$$\sim M = M ⊕ \{ k \{ 1 \} \} . \qquad ( 78 )$$

{k {1}} in equation (78) represents “1” repeating k bits. In other words, {8 {1}} is equal to 0xFF. Next, it is assumed that M1 and M2 are also k-bit variables, the inverse of (M1⊕M2) is as shown in equation (79):

$$\sim ( M 1 ⊕ M 2 ) = ( M 1 ⊕ M 2 ) ⊕ \{ k \{ 1 \} \} = M 1 ⊕ ( M 2 ⊕ \{ k \{ 1 \} \} ) = ( M 1 ⊕ \{ k \{ 1 \} \} ) ⊕ M 2. \qquad ( 79 )$$

Since XOR mask has the characteristics of associative property, the adjustment of value position of {k {1}} will be as shown in equation (79). Then, we can rewrite equation (78) into equation (80).

$$\sim ( M 1 ⊕ M 2 ) = ( M 1 ⊕ \sim M 2 ) = ( \sim M 1 ⊕ M 2 ) . \qquad ( 80 )$$

According to equations (71) and (72), we can know that a+b=o, and by subtracting o on both sides of the equal sign, we can get equation (81).

$$a + b - 0 = 0 . \qquad ( 81 )$$

Because of the 2's complement notation, we can use equation (77) to write equation (81) into equation (82).

$$a + b + \sim 0 + 1 = 0. \qquad ( 82 )$$

Then, the first data a, the second data b, and ˜o and the corresponding first mask value ra, the second mask value rb, and the third mask value ro are brought into the equation (76) and the equation (75) and obtain equation (83) and equation (84) respectively.

$$SCSA ( {a}^{′} , {b}^{′} , \sim {o}^{′} , ra , rb , ro , Rsum ) = ( Sout , Cout ≪ 1 ) ; \qquad ( 83 )$$

$$( Sout ⊕ Rsum ) + ( Cout ⊕ ra ) ≪ 1 = ( {a}^{′} ⊕ ra ) + ( {b}^{′} ⊕ rb ) + ( \sim {o}^{′} ⊕ ro ) . \qquad ( 84 )$$

According to the result of equation (80), the inverse operation of the third operand of the equation on the right side of equation (74) (i.e., ˜) is transferred outside the parentheses, as shown in equation (85):

$$( Sout ⊕ Rsum ) + ( Cout ⊕ ra ) ≪ 1 = ( {a}^{′} ⊕ ra ) + ( {b}^{′} ⊕ rb ) + \sim ( {o}^{′} ⊕ ro ) . \qquad ( 85 )$$

Next, according to equation (74), after removing the first mask value ra, the second mask value rb, and the third mask value ro, equation (86) can be obtained.

$$( Sout ⊕ Rsum ) + ( Cout ⊕ ra ) ≪ 1 = a + b + \sim o . \qquad ( 86 )$$

Based on the 2's complement notation, the equation (86) can be written as the equation (87) using the equation (77).

$$( Sout ⊕ Rsum ) + ( Cout ⊕ ra ) ≪ 1 = a + b - o - 1. \qquad ( 87 )$$

Based on the result of equation (81), equation (88) can be obtained.

$$( Sout ⊕ Rsum ) + ( Cout ⊕ ra ) ≪ 1 = - 1. \qquad ( 88 )$$

(Sout⊕Rsum) is subtracted from both sides of equation (88) at the same time to form equation (89).

$$( Cout ⊕ ra ) ≪ 1 = - ( Sout ⊕ Rsum ) - 1. \qquad ( 89 )$$

Based on the 2's complement notation, the equation (89) can be written as the equation (90) using the equation (77).

$$( Cout ⊕ ra ) ≪ 1 = \sim ( Sout ⊕ Rsum ) + 1 - 1. \qquad ( 90 )$$

Then, +1 value is used to eliminate the −1 value to form equation (91).

$$( Cout ⊕ ra ) ≪ 1 = \sim ( Sout ⊕ Rsum ) . \qquad ( 91 )$$

In order to simplify the equation (91), the input variable Rsum can be specified as the first mask value ra left-shifted by one bit (i.e., ra<<1), as shown in the equation (92):

$$Rsum = ra ≪ 1. \qquad ( 92 )$$

Therefore, equation (91) can be rewritten into equation (93).

$$( Cout ⊕ ra ) ≪ 1 = \sim ( Sout ⊕ ( ra ≪ 1 ) ) . \qquad ( 93 )$$

According to the result of equation (80), the inverse operation of the parentheses (that is, ˜) is transferred to the front of Sout, as shown in equation (94).

$$( Cout ⊕ ra ) ≪ 1 = \sim Sout ⊕ ( ra ≪ 1 ) . \qquad ( 94 )$$

Rewrite both sides of the equation (94) into equation (95) by performing the XOR operation on (ra<<1) at the same time.

$$Cout ≪ 1 = - \sim Sout . \qquad ( 95 )$$

It should be noted that under the conditions of equation (92) and when the secure carry-lookahead addition operation of the secure carry-lookahead adder 150 is correct, the secure carry-lookahead adder 162 does the first masked data a′, the second masked data b′, the inverted sum output ˜o′, the sum data Sout, and the carry data Cout generated by performing the secure carry-save addition operation should comply with the relationship shown in equation (95).

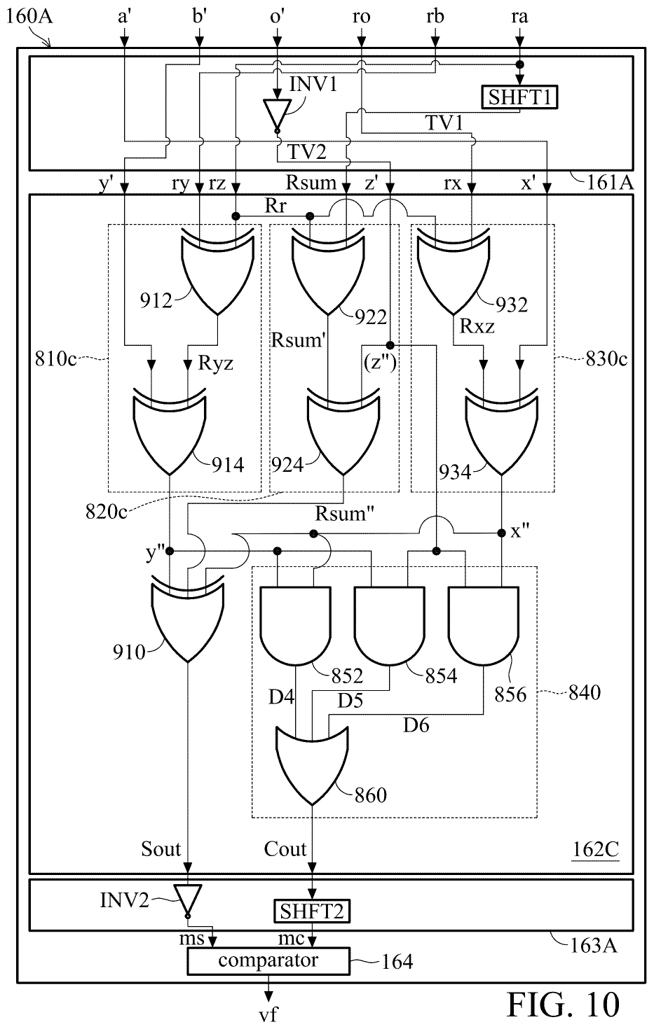

FIG. 10 is a circuit diagram showing a verification circuit in accordance with an embodiment of the present invention. As shown in FIG. 10, the verification circuit 160A includes a first conversion circuit 161A, a secure carry-save adder 162C, a second conversion circuit 163A, and a comparator 164. In this embodiment, the verification circuit 160A includes the secure carry-save adder 162C in FIG. 9C as an example for explanation. In other embodiments, the verification circuit 160A may also include the secure carry-save adder 162A in FIG. 9A or the secure carry-save adder 162B in FIG. 9B.

The first conversion circuit 161A includes a first shift circuit SHFT1 and a first inverter INV1. The first shift circuit SHIFT1 is used to shift the first mask value ra to the left by one bit to generate a first conversion variable TV1, where the first conversion variable TV1 is equal to (ra<<1). The first inverter INV1 is used to invert the sum output o′ to generate a second conversion variable TV2, where the second conversion variable TV2 is equal to the inverted sum output ˜o′.

The second conversion circuit 163A includes a second shift circuit SHFT2 and a second inverter INV2. The second shift circuit SHFT2 is used to left-shift the carry data Cout by one bit to generate the converted carry data mc, where the converted carry data mc is equal to (Cout<<1). The second inverter INV2 is used to invert the sum data Sout to generate converted sum data ms, where the converted sum data ms is equal to the inverted sum data ˜Sout.

As shown in FIG. 10, the verification circuit 160A uses equation (83), equation (92), and equation (95) to ensure the correctness of the secure carry-lookahead addition operation performed by the secure carry-lookahead adder 150. Furthermore, the comparator 164 compares whether the converted sum data ms and the converted carry data mc are equal to generate a verification result vf. When the converted sum data ms and the converted carry data mc are equal, it means that the condition of equation (95) is met. Therefore, the external circuit can confirm correctness of the secure carry-lookahead addition performed by the secure carry-lookahead adder 150 by verifying the result vf.

Next, the verification circuit 160A can be optimized. By substituting equation (70) into equation (69), equation (96) can be obtained.

$$Sout = {x}^{″} ⊕ {y}^{″} ⊕ {Rsum}^{′} ⊕ {z}^{″} . \qquad ( 96 )$$

As shown in FIG. 10, it can be seen that the seventh masked data z″ is equal to the inverted value of the third input data z′ (i.e., the fifth inverted input data ˜z′). Therefore, equation (96) can be rewritten as equation (97).

$$Sout = {x}^{″} ⊕ {y}^{″} ⊕ {Rsum}^{′} ⊕ \sim {z}^{′} . \qquad ( 97 )$$

Next, both sides of the equal sign of equation (97) are inverted simultaneously to obtain equation (98).

$$\sim Sout = \sim ( {x}^{″} ⊕ {y}^{″} ⊕ {Rsum}^{′} ⊕ \sim {z}^{′} ) . \qquad ( 98 )$$

According to the result of equation (80), the inversion operation (i.e., ˜) is moved to the front of the inversion value of the third input data z′ (i.e., the fifth inversion input data ˜z′), as shown in the equation (99) is shown as:

$$\sim Sout = {x}^{″} ⊕ {y}^{″} ⊕ {Rsum}^{′} ⊕ \sim ( \sim {z}^{′} ) . \qquad ( 99 )$$

Then, the two inversion operations can cancel each other, as shown in equation (100):

$$\sim Sout = {x}^{″} ⊕ {y}^{″} ⊕ {Rsum}^{′} ⊕ {z}^{′} . \qquad ( 100 )$$

As shown in equation (100), after the seventh masked data z″ input to the thirteenth XOR gate 924 in FIG. 10 is substituted by the third input data z′, the second inverter INV2 of the second conversion circuit 163 in FIG. 10 can be omitted. Therefore, equation (95) can be rewritten as equation (101).

$$Cout ≪ 1 = Sout . \qquad ( 101 )$$

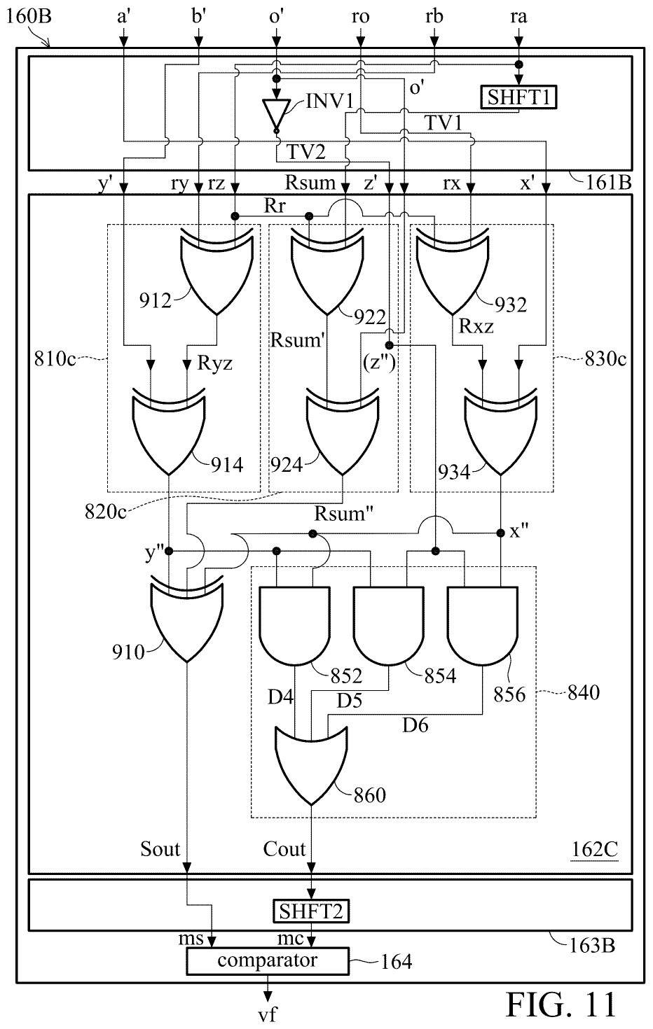

FIG. 11 is a circuit diagram showing a verification circuit in accordance with another embodiment of the present invention. Compared with the verification circuit 160A, the second conversion circuit 163B of the verification circuit 160B lacks the second inverter INV2, and the sum output o′ is directly provided to the input of the thirteenth XOR gate 924. In other words, the thirteenth XOR gate 924 is configured to perform a mask operation on the sum output o′ according to the seventh variable Rsum′, so as to obtain the eighth variable Rsum″, so that the second inverter INV2 of the second conversion circuit 163A can be omitted.

Since the second conversion circuit 163B lacks the second inverter INV2, the converted sum data ms is equal to the sum data Sout, and the converted carry data mc is equal to (Cout<<1). The comparator 164 compares whether the converted sum data ms and the converted carry data mc are equal to generate a verification result vf. In other words, the verification circuit 160B determines whether the condition of equation (101) holds to ensure the correctness of the secure carry-lookahead addition operation performed by the secure carry-lookahead adder 150.

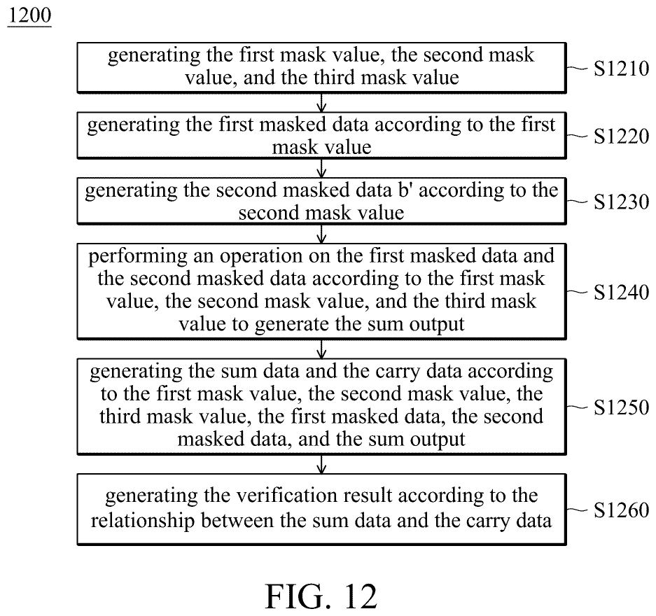

FIG. 12 is a flowchart showing an execution method for executing secure addition in accordance with an embodiment of the present invention. The following description of the execution method 1200 in FIG. 12 will be combined with the secure adder 100 in FIG. 1 for detailed explanation.

As shown in FIG. 12, the mask generator 120 is used to generate the first mask value ra, the second mask value rb, and the third mask value ro (step S1210). Next, the mask generator 120 is used to generate the first masked data a′ according to the first mask value ra (step S1220), generate the second masked data b′ according to the second mask value rb (step S1230). The secure carry-lookahead adder 150 is used to perform an operation on the first masked data a′ and the second masked data b′ according to the first mask value ra, the second mask value rb, and the third mask value ro to generate the sum output o′ (step S1240).

The secure carry-save adder 162 is used to generate the sum data Sout and the carry data Cout according to the first mask value ra, the second mask value rb, the third mask value ro, the first masked data a′, the second masked data b′, and the sum output o′ (step S1250). Finally, the comparator 164 is configured to generate the verification result vf according to the relationship between the sum data Sout and the carry data Cout (step S1260).

The present invention proposes a secure adder that utilizes a secure carry-save adder to verify the operation result of the secure carry-lookahead adder. Since the secure adder used in the verification circuit proposed by the present invention and the secure adder that performs secure operations belong to two different sets of circuits, and their execution times are also staggered, thereby greatly increasing the difficulty of fault collision occurred in the secure adder.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A secure adder, comprising:
a mask generator, configured to generate a first mask value, a second mask value and a third mask value, to generate first masked data according to the first mask value, and to generate second masked data according to the second mask value;
a secure carry-lookahead adder, performing an operation on the first masked data and the second masked data according to the first mask value, the second mask value, and the third mask value to generate a sum output; and
a verification circuit, comprising:
a secure carry-save adder, generating sum data and carry data according to the first mask value, the second mask value, the third mask value, the first masked data, the second masked data, and the sum output; and
a comparator, generating a verification result according to a relationship between the sum data and the carry data.

2. The secure adder as claimed in claim 1, wherein the secure carry-lookahead adder further comprises:
a first exclusive-OR (XOR) gate, configured to receive the first mask value and the second mask value, to provide a variable;
a second mask unit, configured to perform a third mask operation on the first masked data according to the variable, to obtain third masked data;
a half adder, configured to receive the third masked data and the second masked data, to generate a propagation value and an intermediate generation value;
a third mask unit, configured to perform a fourth mask operation on the propagation value according to the third mask value, to obtain fourth masked data;
a first logic circuit, configured to provide a generation value according to the propagation value, the intermediate generation value, and the second mask value;
a carry-lookahead generator, configured to provide a carry output and a carry value according to a carry input, the generation value, and the propagation value; and
a second XOR gate, configured to receive the fourth masked data and the carry value, to provide a sum output.

3. The secure adder as claimed in claim 2, wherein the second mask unit comprises:
a third XOR gate, configured to receive the variable and the first masked data, to provide the third masked data.

4. The secure adder as claimed in claim 2, wherein the third mask unit comprises:
a fourth XOR gate, configured to receive the third mask value and the propagation value, to provide the fourth masked data.

5. The secure adder as claimed in claim 4, wherein the half adder comprises:
a first AND gate, configured to receive the third masked data and the second masked data, to provide the intermediate generation value; and
a fifth XOR gate, configured to receive the third masked data and the second masked data, to provide the propagation value.

6. The secure adder as claimed in claim 2, wherein the logic circuit comprises:
a sixth XOR gate, configured to receive the intermediate generation value and the second mask value, to provide first intermediate data;
a second AND gate, configured to receive the propagation value and the second mask value, to provide second intermediate data; and
a seventh XOR gate, configured to receive the first intermediate data and the second intermediate data, to provide the generation value.

7. The secure adder as claimed in claim 2, further comprising:
a bus interface, configured to provide the first data and the second data from a bus to the mask generator.

8. The secure adder as claimed in claim 7, further comprising:
a selection circuit, configured to selectively provide the first mask value, the second mask value, the third mask value, the first masked data and the second masked data from the mask generator or the first mask value, the second mask value, the third mask value, the first masked data, and the second masked data generated by an external circuit from the bus to the carry-lookahead generator; and
a storage circuit, coupled between the selection circuit and the carry-lookahead adder, and configured to store the first mask value, the second mask value, the third mask value, the first masked data, and the second masked data from the selection circuit.

9. The secure adder as claimed in claim 1, wherein the mask generator comprises:
a random number generator, configured to randomly generate the first mask value, the second mask value, and the third mask value; and
a first mask unit, configured to perform a first mask operation on first data according to the first mask value to obtain the first masked data, and performing a second mask operation on second data according to the second mask value to obtain the second masked data.

10. The secure adder as claimed in claim 1, wherein the secure carry-save adder comprises:
a fourth mask unit, configured to perform a fifth mask operation according to the first mask value, a first conversion variable, the sum output, and a second conversion variable to obtain a first variable;
a fifth mask unit, configured to perform a sixth mask operation on the second masked data according to the first mask value and the second mask value to obtain fifth masked data;
a sixth mask unit, configured to perform a seventh mask operation on the first masked data according to the first mask value and the third mask value to obtain sixth masked data; and
an eighth XOR gate, configured to receive the fifth masked data, the sixth masked data, and the first variable to provide sum data of the first masked data, the second masked data, and the sum output.

11. The secure adder as claimed in claim 10, wherein the secure carry-save adder further comprises:
a second logic circuit, configured to receive the fifth masked data, the sixth masked data, and the second conversion variable to provide the first masked data, the second masked data, and the carry data of the sum output.

12. The secure adder as defined in claim 11, wherein the second logic circuit comprises:
a third AND gate, configured to receive the fifth masked data and the sixth masked data to provide first intermediate data;
a fourth AND gate, configured to receive the fifth masked data and the second conversion variable to provide second intermediate data;
a fifth AND gate, configured to receive the sixth masked data and the second conversion variable to provide third intermediate data; and
an OR gate, configured to receive the first intermediate data, the second intermediate data, and the third intermediate data to provide the carry data.

13. The secure adder as claimed in claim 10, wherein the verification circuit further comprises:
a first conversion circuit, comprising:
a first shift circuit, left-shifting the first mask value to generate the first conversion variable; and
a first inverter, inverting the sum output to generate the second conversion variable.

14. The secure adder as defined in claim 10, wherein the fifth mask unit comprises:
a ninth XOR gate, configured to receive the first mask value and the second mask value to provide a third variable; and
a tenth XOR gate, configured to receive the third variable and the second masked data to provide the fifth masked data.

15. The secure adder as claimed in claim 10, wherein the sixth mask unit comprises:
an eleventh XOR gate, configured to receive the first mask value and the third mask value to provide a fourth variable; and
a twelfth XOR gate, configured to receive the fourth variable and the first masked data to provide the sixth masked data.

16. The secure adder as claimed in claim 10, wherein the fourth mask unit comprises:
a thirteenth XOR gate, configured to receive the first mask value and the first conversion variable to provide a second variable; and
a fourteenth XOR gate, configured to receive the second variable and the sum output to provide the first variable.

17. The secure adder as claimed in claim 16, wherein the verification circuit further comprises:
a second conversion circuit, comprising:
a second shift circuit, left-shifting the carry data by one bit to generate a left-shifted carry data;
wherein the comparator is configured to compare the sum data and the left-shifted carry data;
wherein when the sum data is equal to the left-shifted carry data, the verification result indicates that the operation of the secure carry-lookahead adder is correct.

18. The secure adder as claimed in claim 10, wherein the fourth mask unit comprises:
a thirteenth XOR gate, configured to receive the first mask value and the first conversion variable to provide a second variable; and
a fourteenth XOR gate, configured to receive the second variable and the second conversion variable to provide the first variable.

19. The secure adder as claimed in claim 18, wherein the verification circuit further comprises:
a second conversion circuit, comprising:
a second shift circuit, left-shifting the carry data by one bit to generate a left-shifted carry data; and
a second inverter, inverting the sum data to generate inverted sum data;
wherein the comparator is configured to compare the inverted sum data and the left-shifted carry data;
wherein when the sum data is equal to the left-shifted carry data, the verification result indicates that the operation of the secure carry-lookahead adder is correct.

20. An execution method for executing secure addition, comprising:
generating a first mask value, a second mask value, and a third mask value;
generating first masked data according to the first mask value;
generating second masked data according to the second mask value;
performing an operation on the first masked data and the second masked data according to the first mask value, the second mask value, and the third mask value to generate a sum output;
generating sum data and carry data according to the first mask value, the second mask value, the third mask value, the first masked data, the second masked data, and the sum output; and
generating a verification result according to a relationship between the sum data and the carry data.
